(19) United States
(12) Patent Application Publication
(10) Pub. No.: US 2025/0094821 A1
(43) Pub. Date: Mar. 20, 2025

(54) MULTI-TASK FINE-TUNING FOR PLANNING PERFORMED BY LARGE LANGUAGE MODEL

(71) Applicant: Oracle International Corporation, Redwood Shores, CA (US)

(72) Inventors: Bhagya Gayathri Hettige, Melbourne (AU); Ahmed Ataallah Ataallah Abobakr, Geelong (AU); Vanshika Sridharan, San Mateo, CA (US); Yakupitiyage Don Thanuja Samodhye Dharmasiri, Melbourne (AU); Ying Xu, Albion (AU); Thanh Long Duong, Melbourne (AU); Srinivasa Phani Kumar Gadde, Fremont, CA (US); Vishal Vishnoi, Redwood City, CA (US)

(73) Assignee: Oracle International Corporation, Redwood Shores, CA (US)

(21) Appl. No.: 18/885,496

(22) Filed: Sep. 13, 2024

Related U.S. Application Data
(60) Provisional application No. 63/583,225, filed on Sep. 15, 2023.
(60) Provisional application No. 63/583,028, filed on Sep. 15, 2023.

(51) Int. Cl. G06N 3/096; G06N 3/0475

(52) U.S. Cl. CPC G06N 3/096; G06N 3/0475

(57) ABSTRACT

Techniques are disclosed for fine-tuning a pre-trained machine learning model to be used by a digital assistant for supporting a user's interactions. In one aspect, a method includes accessing a set of training examples, generating a set of synthesized training examples using an iterative process including accessing a dialog script and corresponding prompt template and response template for a predefined scenario, generating one or more prompts based on the dialog script and corresponding prompt template, generating one or more responses associated with each of the one or more prompts based on the dialog script and the response template, and linking each of the responses with the associated prompts to generate one or more synthesized training examples in the set of synthesized training examples. The pre-trained machine learning model is then fine-tuned using the set of training examples and the set of synthesized training examples.

### CROSS-REFERENCE TO RELATED APPLICATIONS

The present application claims priority and benefit from U.S. Provisional Application No. 63/583,225, filed Sep. 15, 2023, and U.S. Provisional Application No. 63/583,028, filed Sep. 15, 2023, the entire contents of which are incorporated herein by reference for all purposes.

### FIELD

The present disclosure relates generally to digital assistants, and more particularly, to techniques for multi-task finetuning (routing and slot-filling) performed by a Large Language Model (LLM) in a digital assistant input pipeline and response generation.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method can be used for fine-tuning a pre-trained machine learning model to be used by a digital assistant for supporting a user's interactions. The method can include accessing a set of training examples, wherein each training example of the set of training examples includes a dialog script between a user and a digital assistant, generating a set of synthesized training examples using an iterative process that is performed for each of one or more predefined scenarios, wherein the iterative process includes: (i) accessing a dialog script and corresponding prompt template and response template for a predefined scenario, wherein the prompt template includes prompt placeholders associated with candidate actions, context, and an utterance, and wherein the response template includes response placeholders associated with executable actions; (ii) generating one or more prompts based on the dialog script and corresponding prompt template for the predefined scenario, wherein generating the one or more prompts includes inserting prompt values into the prompt placeholders associated with the candidate actions, the context, and the utterance based on the dialog script for the predefined scenario; (iii) generating one or more responses associated with each of the one or more prompts based on the dialog script and the response template for the predefined scenario, wherein generating the one or more responses includes inserting response values into the response placeholders associated with the executable actions based on the dialog script for the predefined scenario and the associated one or more prompts; and (iv) linking each of the one or more responses with each of the associated one or more prompts to generate one or more synthesized training examples in the set of synthesized training examples. The pre-trained machine learning model is then fine-tuned using the set of training examples and the set of synthesized training examples. The pre-trained machine learning model is configured to learn tasks of action routing and slot-filling for generating an execution plan, wherein the action routing includes identifying one or more of the executable actions from one or more of the candidate actions that are relevant for responding to the utterance based on the context, and slot-filling includes inserting values into argument slots associated with the one or more executable actions based on the context.

In some embodiments, generating the one or more prompts and the one or more responses further comprises selecting, using a random or predefined data split scheme, the prompt values for the prompt placeholders and the response values for the response placeholders based on the dialog script for the predefined scenario, and wherein the random or predefined data split scheme causes the prompt values and the response values to be selected in such a manner that variation within the one or more prompts and the one or more responses is realized in a number of the candidate actions and/or executable actions, type of the candidate actions and/or executable actions, number of tasks within the context, type of tasks within the context, number of argument slots to be filled within the context and/or executable actions, type of argument slots to be filled within the context and/or executable actions, or any combination thereof when the prompt values and the response values are inserted into the prompt placeholders and the response placeholders, respectively.

In some embodiments, the dialog script for the predefined scenario comprises an in-order dialog flow between a user and a digital assistant, an out of order dialog flow between a user and a digital assistant, or at least a portion of a dialog flow between a user and a digital assistant does not logically flow from another portion of the dialog flow.

In some embodiments, the prompt placeholders associated with the candidate actions include one or more argument slots to be filled by the digital assistant, and the response placeholders associated with the executable actions include the one or more argument slots filled with one or more response values.

In some embodiments, the prompt placeholders associated with the context include at least a portion of an execution plan, the execution plan comprises an action including at least one argument slot having missing values, the utterance comprises information for filling in the missing values, the response placeholders associated with the executable actions include the action including the at least one argument slot, and the at least one argument slot is filled in with one or more response values derived from the information in the utterance.

In some embodiments, the fine-tuning includes generating batches of examples selected from the set of training examples and the set of synthesized training examples; and performing an iterative training loop process that includes: inputting examples from the batches into the pre-trained machine learning model; for each batch, computing a loss for the task of action routing; for each batch, computing a loss for the task of slot-filling; and optimizing model parameters based on a combined loss function that takes into account the loss for the task of action routing and the loss for the task of slot-filling.

In some embodiments, the one or more prompts and the one or more responses are generated using a generative artificial intelligence model.

Some embodiments include a system including one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a chatbot system in accordance with various embodiments.

FIG. 2 is an exemplary architecture for an LLM-based digital assistant in accordance with various embodiments.

FIG. 3 is a block diagram of an exemplary machine learning pipeline comprising several subsystems that work together to train, validate, and implement one or more machine learning models to be used in or by a digital assistant in accordance with various embodiments.

FIG. 4 is a block diagram of an exemplary system for fine-tuning large language models in accordance with various embodiments.

FIG. 5 is a flowchart of a process for fine-tuning large language models in accordance with various embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Artificial intelligence techniques have broad applicability. For example, a digital assistant is an artificial intelligence driven interface that helps users accomplish a variety of tasks using natural language conversations. Conventionally, for each digital assistant, a customer may assemble one or more skills that are focused on specific types of tasks, such as tracking inventory, submitting timecards, and creating expense reports. When an end user engages with the digital assistant, the digital assistant evaluates the end user input for the intent of the user and routes the conversation to and from the appropriate skill based on the user's perceived intent. However, there are some disadvantages of traditional intent-based skills including a limited understanding of natural language, inability to handle unknown inputs, limited ability to hold natural conversations off script, and challenges integrating external knowledge.

The advent of large language models (LLMs) like Generative Pretrained Transformer 4 (GPT-4) has propelled the field of digital assistant design to unprecedented levels of sophistication and overcome these disadvantages and others of traditional intent-based skills. An LLM is a neural network that employs a transformer architecture, specifically crafted for processing and generating sequential data, such as text or words in conversations. LLMs undergo training with extensive textual data, gradually honing their ability to generate text that closely mimics human-written or spoken language. While LLMs excel at generalizing to novel scenarios and domains, it is important to note that their output is not guaranteed to be entirely accurate and is some instances they are prone to hallucinations.

Hallucinations refer to instances where the AI generates information that is incorrect, misleading, or fabricated, despite being presented in a confident and plausible manner. These hallucinations pose significant challenges, particularly in various enterprise contexts, as they can lead to the dissemination of inaccurate information, misinterpretation of information, or reliance on non-existent information, ultimately affecting the quality and reliability of responses and decisions. Consequently, it is important to ensure that an LLM adheres to the natural language configuration commands with fidelity without mistake. Additionally, addressing hallucinations requires ongoing refinement of the model, rigorous validation protocols, and continuous monitoring to ensure that the AI's outputs remain accurate and trustworthy. This adds complexity to the deployment and maintenance of LLMs in various enterprise settings where precision and reliability are paramount.

To address these challenges and others, techniques are disclosed herein for fine-tuning LLMs (e.g., further training LLMs on specific tasks) to enhance their understanding of assets that will be used when performing as an agent (including application programming interfaces (APIs)) and to undergo instruction fine-tuning to improve the LLMs' ability to conform to natural language commands. From a capability point of view, this enables an end user to configure various assets such as APIs, Knowledge Documents, and databases (DBs) for a digital assistant and interact with these assets using natural language. Additionally, through fine-tuning, the LLMs are taught to adhere to user guidelines and output formats, such as JavaScript Object Notation (JSON), which can be validated, thus significantly reducing the risk of hallucination.

These techniques address the technical challenges above because by tailoring the LLMs to particular domains or tasks, such as action matching (routing) and slot-filling, the LLMs can learn to recognize and prioritize relevant information, reducing the likelihood of generating erroneous or fabricated content. Fine-tuning involves training the LLMs on specialized datasets that are representative of the specific tasks it will perform, ensuring it understands the context, terminology, and nuances unique to those areas. This process helps in refining the model's parameters and improving its ability to discern between accurate and inaccurate information. Moreover, the fine-tuning allows for the incorporation of domain or task-specific knowledge and validation protocols that can further enhance the model's performance and reliability, ultimately leading to more accurate and trustworthy outputs. In the context of routing and slot-filling, this means more accurate selection and execution of assets such as APIs, Knowledge Documents, and DBs and improved interaction with these assets using natural language, thereby addressing the technical challenges posed by hallucinations. Experiments were run comparing the fine-tuned models versus conventional (non-fine-tuned) models and performance improvement (measured via accuracy in predictions) was demonstrated at between 5% and 25% for the routing task and between 25% and 50% for the slot-filling task.

In various embodiments, a computer-implemented method can be used for fine-tuning a pre-trained machine learning model to be used by a digital assistant for supporting a user's interactions. The method can include accessing a set of training examples, wherein each training example of the set of training examples includes a dialog script between a user and a digital assistant, generating a set of synthesized training examples using an iterative process that is performed for each of one or more predefined scenarios, wherein the iterative process includes: (i) accessing a dialog script and corresponding prompt template and response template for a predefined scenario, wherein the prompt template includes prompt placeholders associated with candidate actions, context, and an utterance, and wherein the response template includes response placeholders associated with executable actions; (ii) generating one or more prompts based on the dialog script and corresponding prompt template for the predefined scenario, wherein generating the one or more prompts includes inserting prompt values into the prompt placeholders associated with the candidate actions, the context, and the utterance based on the dialog script for the predefined scenario; (iii) generating one or more responses associated with each of the one or more prompts based on the dialog script and the response template for the predefined scenario, wherein generating the one or more responses includes inserting response values into the response placeholders associated with the executable actions based on the dialog script for the predefined scenario and the associated one or more prompts; and (iv) linking each of the one or more responses with each of the associated one or more prompts to generate one or more synthesized training examples in the set of synthesized training examples. The pre-trained machine learning model is then fine-tuned using the set of training examples and the set of synthesized training examples. The pre-trained machine learning model is configured to learn tasks of action routing and slot-filling for generating an execution plan, wherein the action routing includes identifying one or more of the executable actions from one or more of the candidate actions that are relevant for responding to the utterance based on the context, and slot-filling includes inserting values into argument slots associated with the one or more executable actions based on the context.

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Digital Assistant and Knowledge Dialog

A bot (also referred to as an agent, chatbot, chatterbot, or talkbot), implemented as part of or as a digital assistant, is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile, web, and cloud application extensions or plugins that extend native or hybrid/responsive mobile, web, or cloud applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or preprocessed for input to a bot that is identified to be associated with the invocation name and/or communication.

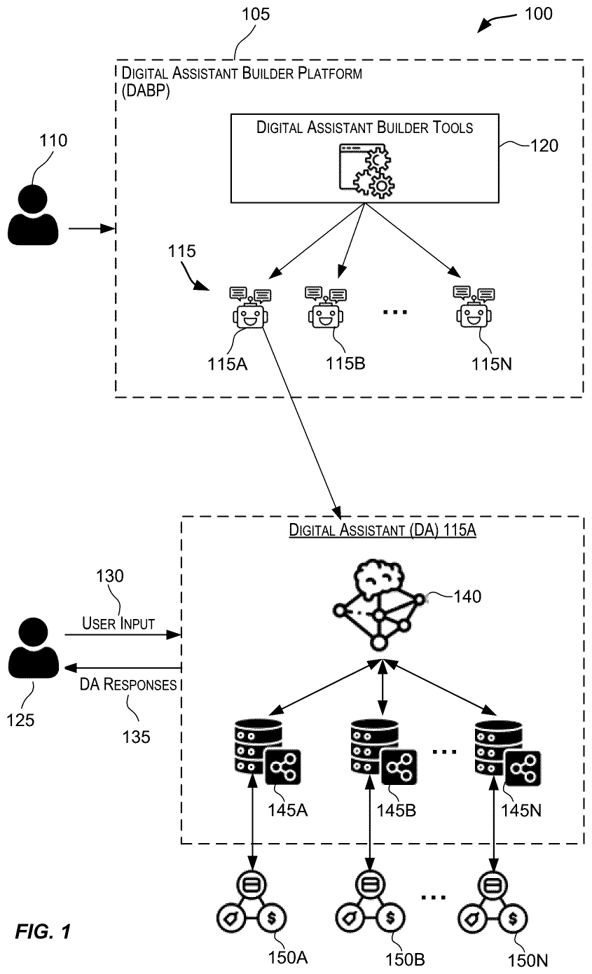

FIG. 1 is a simplified block diagram of an environment 100 incorporating a digital assistant system (also described herein as simply a digital assistant or in more specific terms with reference to implementation of agents as an agent assistant) according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistant systems (or DAs). For example, as illustrated in FIG. 1, user 110 representing a particular enterprise can use DABP 105 to create and deploy a digital assistant 115A for users of the particular enterprise (e.g., user 125). For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

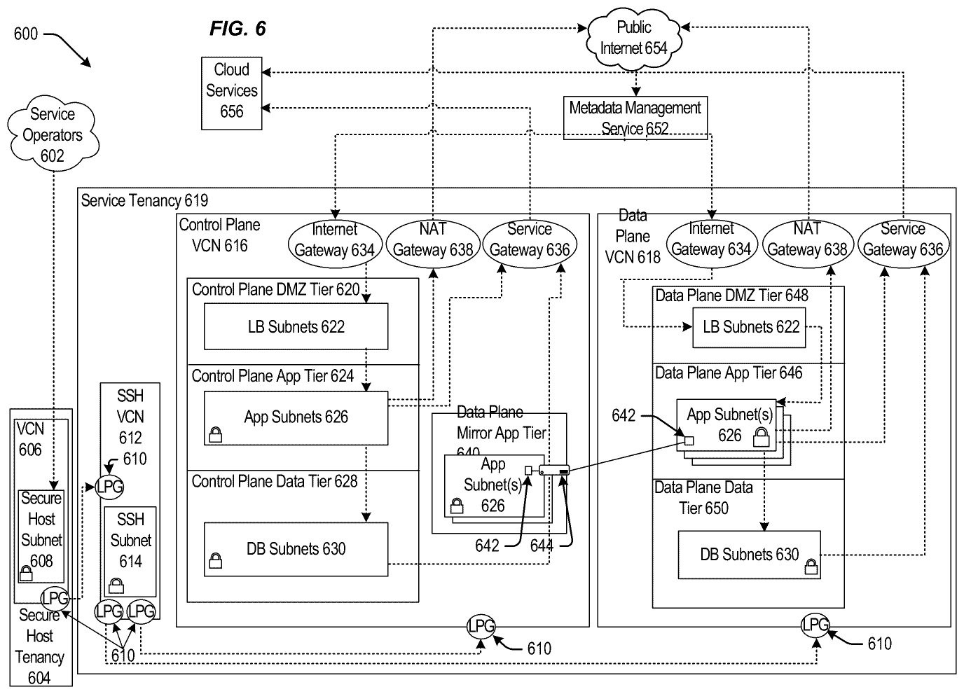

To create one or more digital assistant systems 115, the DABP 105 is equipped with a suite of tools 120, enabling the acquisition of LLMs, agent creation, asset identification, and deployment of digital assistant systems within a service architecture for users via a computing platform such as a cloud computing platform described in detail with respect to FIGS. 6-10. In some instances, the tools 120 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions that an end-user can end up invoking. An agent is a container of agent actions and can be part of one or more digital assistants. Each digital assistant may contain one or more agents through a digital assistant relation, which is the intersection entity that links an agent to a digital assistant. The agent and digital assistant are implemented as bot subtypes and may be persisted into an existing BOTS table. This has advantages in terms of reuse of design-time code (e.g., Java code) and UI artifacts.

An agent action is of a specific action type (e.g., knowledge, service or API, LLM, etc.) and contains a description and schema (e.g., JSON schema) which defines the action parameters. The action description and parameters schema are indexed by semantic index and sent to a planner LLM to select the appropriate action(s) to execute. The action parameters are key-value pairs that are input for the action execution. They are derived from the properties in the schema but may also include additional UI/dialog properties that are used for slot-filling dialogs. The actions can be part of one or more classes. For example, some actions may be part of an application event subscription class, which defines an agent action that should be executed when an application event is received. The application event can be received in the form of an update application context command message. An application event property mapping class (part of the application event subscription class) specifically maps the application event payload properties to corresponding agent action parameters. An action can optionally be part of an action group. An action group may be used when importing a plugin manifest, or when importing an external API specification (API spec) such as an Open API spec. An action group is particularly useful when re-importing a plugin or open API spec, so new actions can be added, existing actions can be updated, or actions that are no longer present in the new manifest or Open API spec can be removed. At runtime, an action group may only be used to limit the application context groups that are sent to the LLM as conversation context by looking up the action group name which corresponds to a context group context.

The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user (e.g., a user 110 of DABP 105) can easily create explicit actions. For example, the user 110 can choose the ‘Rich Text’ action type (see Table 1 for a list of exemplary action types) and creates the name artifact ‘What is the impact of XYZ on my 401k Contribution limit?’ when the user 110 learns that a new FAQ needs to be added, as it's not currently in the knowledge documents (assets) the agent references (thus was not implicitly added as an action).

TABLE 1

| | Action Type | Description |
|---|---|---|
| 1 | Prompt | The action is implemented using a prompt to an LLM. |
| 2 | Rich Text | The action is implemented using rich text. The most |
| | | common use case is FAQs. |
| 3 | Flow | The action is implemented using Visual Flow Designer |
| | | flow. May be used for complex cases where the |
| | | developer is not able to use the out-of-the-box |
| | | dialogue and dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

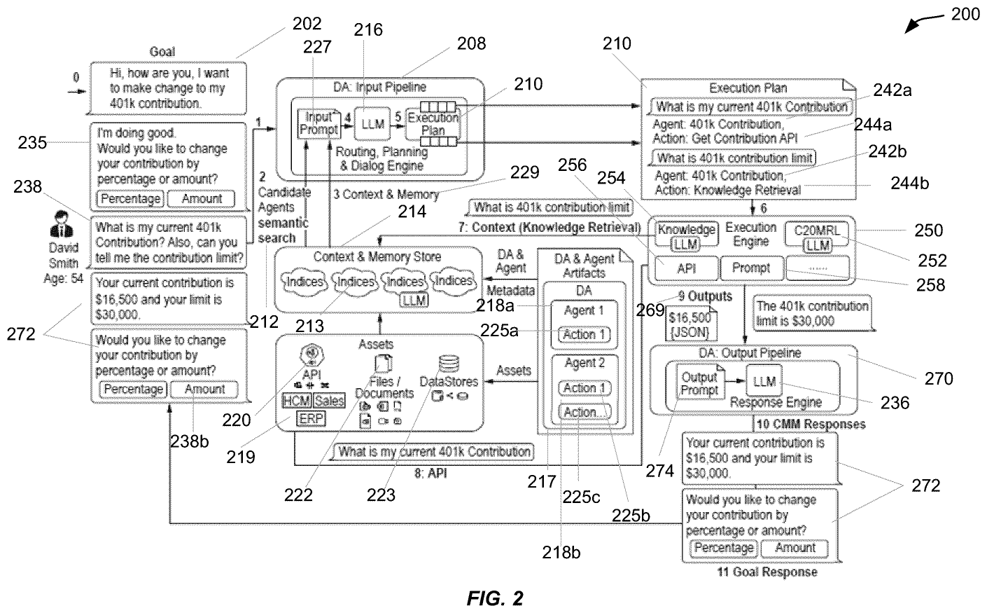

Once deployed in a production environment, such as the architecture described with respect to FIG. 2, a digital assistant, such as a digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A via a user interface element such as a chat window. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140. Conversations shown in the chat window can be organized by thread. For example, in some applications, a conversation related to one page of an application should not be mixed with a conversation related to another page of the application. The application and/or the plugins for the application define the thread boundaries (e.g., a set of (nested) plugins can run within their own thread). Effectively, the chat window will only show the history of messages that belong to the same thread. Setting and changing the thread can be performed via the application and/or the plugins using an update application context command message. Additionally or alternatively, the thread can be changed via an execution plan orchestrator when a user query is matched to a plugin semantic action and the plugin runs in a thread different than the current thread. In this case, the planner changes threads, so that any messages sent in response to the action being executed are shown in the correct new thread. Per agent dialog thread, the following information can be maintained by the digital assistant: the application context, the LLM conversation history, the conversation history with the user, and the agent execution context which holds information about the (stacked) execution plan(s) related to this thread.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pre-trained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A—knowledge, API, Structured Query Language (SQL) operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems and subsystems as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation and/or a series of actions such as interactions with a user interface. The following is a detailed walkthrough of a conversation flow and the role and responsibility of the components, services, models, and the like of the computing environment 200 within a conversation flow. In this walkthrough, it is assumed that a user “David” is interested in making a change to his 401k contribution, and in an utterance 202, David provides the following input: Hi, how are you, I want to make a change to my 401k contribution. The utterance 202 can be communicated to the digital assistant (e.g., via a digital assistant user interface such as a text dialogue box or microphone). At this stage upon receipt of the utterance 202, a sessionizer creates a new session or retrieves the current session context and a user message publisher updates session transcript and LLM message history with the new user message (e.g., utterance 202).

In instances where the user provides the utterance 202 and/or performs an action while using an application supported by a digital assistant, the application issues update application context commands as the user interacts with the application (e.g., provides an utterance via text or audio, triggers a user interface element, navigates between pages of the application, and the like). Whenever an update application context command message is received by the digital assistant from the application, the application context processor (part of the context manager) is implemented. The application context processor performs the following tasks: (i) manages dialog threads based on the application context message, e.g., if the threadId specified with the message doesn't exist yet, a new dialog thread is created and made current, and if the threadId already exists, the corresponding dialog thread is made current, (ii) creates or updates the application context object for the current dialog thread, (iii) if a service call ID such as a REST request ID is included, the application context may be enriched (as described in greater detail herein). As should be understood, the application context only contains information that reflects the state of the application user interface and plugins (if available), it does not contain other state information (e.g., user or page state information/context).

Is some instances, when an update application context command message is received, an application event processor checks on whether the update application context command message includes an event definition. The event is uniquely identified by the following properties in the message payload: (i) context: the context path and/or the plugin path (For a top-level workspace plugin the context is set to the plugin name, for nested plugins the plugin path is included where plugins are separated with a slash, for example Patient/Vitalschart), (ii) eventType: the type of event can be one of the built in events or a custom event, and (iii) semantic object: the semantic object to which the event applies. An event can be mapped to one or more actions, and the message payload properties can be mapped to action parameters. This mapping takes place through an application event subscription. Each property in the message payload can be mapped to an agent action parameter using an application event property mapping.

In some instances, the utterance 202 and/or action performed by the user is provided directly as input to a planner 208. In other instances where the application event processor is implemented, the utterance 202 and/or action performed by the user is provided as input to the planner 208 when the application event processor determines an event such as receipt of utterance 202 is mapped to an agent or action associated with the digital assistant. The planner 208 is used by the digital assistant to create an execution plan 210 with specified parameters either from the utterance 202, the action performed by the user, the context, or any combination thereof. The execution plan 210 identifies one or more agents and/or one or more actions for the one or more agents to execute in response to the utterance 202 and/or action performed by the user.

A two-step approach can be taken via the planner 208 to generate the execution plan 210. First, a search 212 can be performed to identify a list of candidate agents and/or actions. The search 212 comprises running a query on indices 213 (e.g., semantic indices) of a context and memory store 214 based on the utterance 202 and/or action performed by the user. In some instances, the search 212 is a semantic search performed using words from the utterance 202 and/or representative of the action performed by the user. The semantic search uses NLP and optionally machine learning techniques to understand the meaning of the utterance 202 and/or action performed by the user and retrieve relevant information from the context and memory store 214. In contrast to traditional keyword-based searches, which rely on exact matches between the words in the query and the data in the context and memory store 214, a semantic search takes into account the relationships between words, the context of the query and/or action, synonyms, and other linguistic nuances. This allows the digital assistant to provide more accurate and contextually relevant results, making it more effective in understanding the user's intent in the utterance 202 and/or action performed by the user.

In order to run the query, the planner 208 calls the context and memory store 214 (e.g., a semantic index of the context and memory store 214) to get the list of candidate agents and/or actions. The following information is passed in the call: (i) the ID of the digital assistant (the ID scopes the set of agent and/or actions the semantic index will search for and thus the agents and/or actions must be part of the digital assistant), and (ii) the last X number of user messages and/or actions (e.g., X can be set to the last 5 turns), which can be configurable through the digital assistant settings.

The context and memory store 214 is implemented using a data framework for connecting external data to LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request and/or action.

The response of context and memory store 214 is converted into a list of agent and/or action instances that are not just available to the digital assistant for responding to the request but also potentially capable of facilitating the generation of a response to the utterance 202 and/or action performed by the user. The list of candidate agents and/or actions includes the metadata (e.g., metadata extracted from artifacts 217 and assets 219) from the context and memory store 214 that is associated with each of the candidate agents and/or actions. The list can be limited to a predetermined number of candidate agents and/or actions (e.g., top 10) that satisfy the query or can include all agents and/or actions that satisfy the query. The list of candidate agents and/or actions with associated metadata is appended to the utterance 202 and/or action performed by the user to construct an input prompt 227 for the LLM 216. The search 212 is important to the digital assistant because it filters out agents and/or actions that are unlikely to be capable of facilitating the generation of a response to the utterance 202 and/or action performed by the user. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs can take the input prompt as input.

In some instances, one or more knowledge actions are additionally appended to the list of candidate agents and the utterance 202. The knowledge actions allow for additional knowledge to be acquired that is pertinent to the utterance 202 and/or action performed by the user (this knowledge is typically outside the scope of the knowledge used to train an LLM of the digital assistant). There are two types of knowledge action sources: (i) structure: the knowledge source defines a list of pre-defined questions that the user might ask and exposes them as some APIs (e.g., Multum), and (ii) unstructured: with the knowledge source, the user has unlimited ways to ask questions and the knowledge source exposes a generic query interface (e.g., medical documents (SOAP notes, discharge summary, etc.)).

In some instances, conversation context 229 concerning the utterance 202 are additionally appended to the list of candidate agents and the utterance 202. The conversation context 229 can be retrievable from one or more sources including the context and memory store 214, and includes user session information, dialog state, conversation or contextual history, application context, page context, user information, or any combination thereof. For example, the conversation context 229 can include: the current date and time, needed to resolve temporal references in user query like “yesterday”, or “next Thursday”, additional context, which contains information such as user profile properties and application context groups with semantic object properties, and the chat history with the digital assistant (and/or other digital assistant or system internal or external to the computing environment 200.

The second step of the two-step approach is for the LLM 216 to generate an execution plan 210 based on the input prompt 227. The LLM 216 can be invoked by creating an LLM chat message with role system passing in the input prompt 227, converting the candidate agents and/or actions into LLM function definitions, retrieving a proper LLM client based on the LLM configuration options, optionally transforming the input prompt 227, LLM chat message, etc. into a proper format for the LLM client, and sending the LLM chat message to the LLM client for invoking the LLM 216. The LLM client then sends back an LLM success response in common language model interface (CLMI) format or a provider specific response is converted back to the LLM success response in CLMI format using an adapter such as OpenAIAdapter (or send back or is converted to an LLM error response in case an unexpected error occurred). An LLM call instance is created and added to the conversation history which captures all the request and response details including the execution time.

The LLM 216 has a deep generative model architecture (e.g., a reversible or autoregressive architecture) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. For example, to generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage][Amount]) to the input prompt 227 that can obtain the missing information such that the LLM 216 is able to generate a complete execution plan 210. In some instances, the response may be rendered within a dialogue box of a UI having one or more UI elements allowing for an easier response by the user. In other instances, the response may be rendered within a dialogue box of a UI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response—additional query 238—is input into the planner 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

In some instances, the utterance 202 by the user may be determined by the LLM 216 to be non-sequitur (i.e., an utterance that does not logically follow from the previous utterance in a dialogue or conversation). In such an instance, an execution plan orchestrator can be used to handle the switch among different dialog paths. The execution plan orchestrator is configured to track all the ongoing conversation paths, create a new entry if a new dialog path is created and pause the current ongoing conversation if any, remove the entry if the conversation completes based on the metadata of the new action or user preference, it might generate a prompt message when starting a non-sequitur or resuming the previous one, manage the dialog for the prompt message and either proceed or restore the current conversation, confirm or cancel when the user responds to the prompt for the non-sequitur, and manages a cancel or exit from a dialog.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like, for executing the actions of agents and implementing the execution plan 210. For example, the natural language-to-programming language translator 252, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or private network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount?[Percentage][Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

### Block Diagram for Training and Implementation of a Machine Learning Model

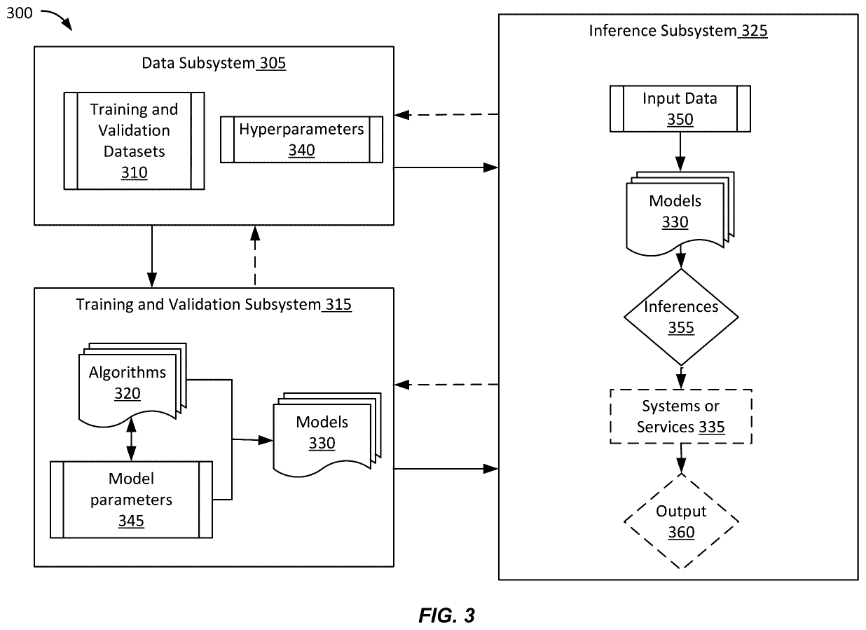

FIG. 3 shows a block diagram of an exemplary machine learning pipeline 300 comprising several subsystems that work together to train, validate, and implement one or more machine learning models to be used in or by a digital assistant in accordance with various embodiments. The machine learning pipeline 300 may be executed as part of the digital assistant builder tools 120 or the one or more of the digital assistants 115 as described in FIG. 1. The machine learning pipeline 300 comprises (i) a data subsystem 305 that is capable for collecting, storing, generating, preprocessing, and labeling of training and validation datasets 310, and collecting, storing, generating, setting, or implementing model hyperparameters 340, (ii) a training and validation subsystem 315 that facilitates the training and validation of one or more machine learning algorithms 320 and the generation of one or more machine learning models 330, and an inference subsystem 325 for deploying and implementing the one or more trained machine learning models 330 independently or in combination with one or more downstream applications 335 for further processes (e.g., providing/generating a response or an execution plan, and/or execute the execution plan).

As used herein, machine learning algorithms (also described herein as simply algorithm or algorithms) are procedures that are run on datasets (e.g., training and validation datasets 310) and extract features from the datasets, perform pattern recognition on the datasets, learn from the datasets, and/or are fit on the datasets. Examples of machine learning algorithms include linear and logistic regressions, decision trees, random forest, support vector machines, principal component analysis, value-based reinforcement learning algorithms, Apriori algorithms, hierarchical clustering, gradient descent algorithms, stochastic gradient descent algorithms, Hidden Markov Model, artificial neural networks, transformers, self-attention mechanisms, k-means clustering, and k-nearest neighbors.

As used herein, machine learning models (also described herein as simply model or models) are the output of the machine learning algorithms and are comprised of model parameters and prediction algorithm(s). In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, a decision tree algorithm may result in a model comprised of a tree of if-then statements with specific values, a random forest algorithm may result in a random forest model that is an ensemble of decision trees for classification or regression, or neural network, backpropagation, and gradient descent algorithms together result in a model comprised of a graph structure with vectors or matrices of weights with specific values.

### (I) Data Subsystem

Data subsystem 305 is used to collect, store, generate, preprocess, and label data to be used by the training and validation subsystem 315 to train, validate, and test one or more machine learning algorithms 320. The data subsystem 305 comprises training and validation datasets 310 and model hyperparameters 340. Raw data may be acquired through a public database, a commercial database, or a private database (e.g., a semantic context and memory store including multiple assets). For example, the data subsystem 305 may access and load datasets (e.g., Schema-Guided Dialogue (SGD)) from public or private data repositories (a data stores 223 described in FIG. 2).

The dataset may include natural language utterances that can include text input, voice input, image input, or any other suitable input for a digital assistant. For example, the input may include text input provided by a user via a keyboard or touchscreen of a computing device used by the user. In other examples, the input may include spoken words provided by the user via a microphone of the computing device. In other examples, the input may include image data, video data, or other media provided by the user via the computing device. Additionally or alternatively, the input may include indications of actions to be performed by the digital assistant on behalf of the user. For example, the input may include an indication that the user wants to order a pizza, that the user wants to update a retirement account contribution, or other suitable indications.

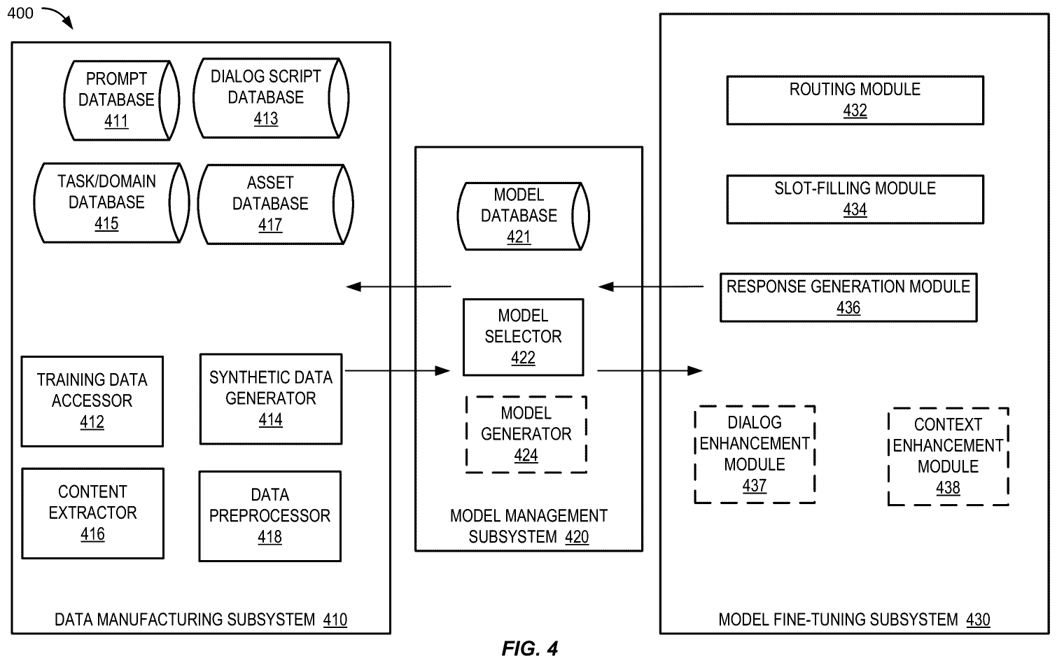

The accessed dataset may be comprised of thousands to millions of annotated multi-domain, task-oriented conversations (e.g., natural language utterances) between a human and a digital assistant. For example, the conversations may cover domains including but not limited to banks, restaurants, events, media, calendar, hotels, flights, travel, and weather. As used herein, the term “domain” and the term “agent” may be used interchangeably. As used herein, the term “task” refers to a specific goal or action that a user wants a digital assistant (or the system) to perform or complete. These tasks are often practical, user-driven activities where the conversation's purpose is to achieve something specific. For example, a task or action can include booking a flight, reserving a table at a restaurant, scheduling an appointment at a clinic, reserving a hotel room, a car, or tickets, ordering a pizza, checking bank account balances, retrieving weather updates, and providing directions to a user-designative location. The data subsystem 305 may also act as a data manufacturing subsystem (e.g., data manufacturing subsystem 410 described below with respect to FIG. 4) to manufacture specific data for fine-tuning a trained machine learning model. In some instances, the manufactured data is based on the accessed raw data. In some instances, the data subsystem 305 generates new data to be used in or as the training and validation datasets 310.

### A. Data Manufacturing

The data subsystem 305 may be configured to manufacture data for training, fine-tuning, validating, and testing the machine learning algorithms 320 and/or the machine learning models 330. Various strategies and techniques may be used for data manufacturing, depending on the type of the algorithms/models and/or the problem domain. Approaches include but are not limited to data augmentation, synthetic data generation, generative models, rule-based approaches, noise injection, programmatic labeling, simulated user interactions, and any combination thereof. More details can be found below and as described with respect to FIG. 4

Data synthesizing involves creating entirely new data points from scratch. This technique may be used when real data or accessed raw data is insufficient, too ideal, too sensitive to use, or when the cost and logistical barriers to obtaining more real data are too high. For example, in the context of LLMs, the accessed raw data obtained from a public database may be “happy data” or “happy paths.” “Happy data” or “happy paths” refer to positive examples of interactions or dialogues where the task or conversation proceeds smoothly and successfully to completion. These are ideal, successful interactions in which the system understands the user's request and provides the correct responses or takes the correct actions without errors, misunderstandings, or corrections. For example, in a dialog between a user and a digital assistant for an ordering-pizza task, the happy path would represent a conversation like:
User: I have an expense from a pizza restaurant.
Assistant: I need to know the amount and the date for this expense. Can you provide the amount first?
User: Sure, the amount was $200.

Training machine learning models, especially LLMs, using only happy data—ideal, error-free interactions—can lead to significant issues, such as generating biased results, lacking robustness, resulting in poor generalization to edge cases, and struggling with handling atypical queries. Particularly, training LLMs may result in hallucinations. Hallucinations can occur when the model generates information that is inaccurate, nonsensical, or fabricated, often because it lacks exposure to the variability and ambiguity present in real-world data. Without encountering ambiguous or incomplete inputs during training, the LLMs become overconfident in providing responses even when it should request clarification or recognize uncertainty. This increases the risk of producing convincing but entirely false outputs, as the model hasn't learned to handle errors, contradictions, or uncertainties that are common in real-world interactions.

To mitigate hallucinations, a possible solution is to train LLMs on a more diverse dataset that includes challenging interactions (e.g., secondary happy paths and/or non-sequitur paths), such as ambiguous, erroneous, incomplete or out-of-order dialog flows. Exposing the LLMs to these types of training data encourages it to recognize when it lacks sufficient information, prompting it to seek clarification or provide more cautious responses instead of fabricating answers. Techniques like reinforcement learning from human feedback (RLHF) can help fine-tune the LLM's behavior, encouraging the models to avoid confident hallucinations and improving their ability to manage uncertainty. Incorporating synthetic error-prone data and simulating real-world conversational difficulties will reduce hallucinations, leading to a more reliable, realistic model.

The synthetic data should be realistic enough to effectively train a machine learning model. For example, an ideal training dataset should include high-quality, diverse and unbiased conversational data. Techniques such as Generative Adversarial Networks (GANs), Variational Autoencoders (VAEs), or LLMs may be used to generate new data examples. These models learn the distribution of real data and attempt to produce new data examples that are statistically similar but not identical. In certain instances, pre-trained LLMs (e.g., an LLM other than the one being trained on synthetic data) can be leveraged to generate new data examples, such as secondary happy path examples, for the purpose of training or fine-tuning another LLM. This synthetic data can be created through a synthetic data generation pipeline, which is designed to populate a training dataset. The pipeline works by defining a series of dialogue scripts between a user and a digital assistant, complete with input/output templates and placeholders for specific slot values. These templates provide structured frameworks, allowing for a wide range of synthetic dialogues to be generated automatically or semi-automatically. An exemplary secondary happy path example with an out-of-order dialog flow generated via the synthetic data generation pipeline is provided below:
User: I have an expense of $100 from a pizza restaurant.
Assistant: Can you provide the date for this expense?
User: Ah the amount was $150.50.
Assistant: Sure, I updated the amount. Can you provide the date for this expense?

Rule-based approaches can additionally or alternatively be used to synthesize data. These rules can be designed to reflect typical language usage within the domain being modeled. For example, fixed templates with placeholders can be used to create various dialogue scenarios. In some instances, conversations can be generated by defining how the conversations or sentences are structured using grammars or linguistic rules.

Noise injection approaches can also be used to synthesize data. By deliberately introducing variations or errors into training data to simulate real-world inputs where users may make typographical errors, use abbreviations, or provide incomplete information. Examples include inserting common spelling mistakes, altering or omitting punctuation to mimic informal or hurried input, and swapping characters randomly within words to imitate mistyped entries.

Simulated user interaction approaches involve generating dialogs mimicking how users might engage with a digital assistant. The approaches usually generate multi-turn, realistic conversations where users ask questions, make requests, or provide feedback. For example, simulating conversational flows allows a planner to script various user-initiated dialogues, such as booking a service, requesting recommendations, or asking for status updates. Similarly, task-oriented dialogue generation focuses on specific tasks like reserving a restaurant table or checking account balances. These simulated interactions create a broad set of conversational data, enabling the model to learn from diverse scenarios and improve its performance across different user interactions. In some instances, multiple approaches can be used in combination to generate desired synthetic data for a specific digital assistant, in a specific domain, or for a specific task. In some instances, multiple approaches can be used in combination to generate desired synthetic data for multiple digital assistants, in multiple domains, or for multiple tasks.

Data augmentation, on the other hand, refers to techniques used to artificially expand the size of a dataset by creating modified versions of existing data examples (e.g., the accessed raw data). The primary goal of data augmentation is to increase variation in the data in order to make the model more robust to variations it might encounter in the real world, thereby improving its ability to generalize from the training data to unseen data. After gathering raw data from various sources, such as web scraping, APIs, databases, or data repositories, transformations can be applied to the gathered raw data. For example, techniques such as paraphrasing, synonym replacement, back-translation, random word deletion or insertion, and/or token shuffling may be used to diversify the raw data, thereby obtaining augmented data.

### B. Data Preprocessing

In some instances, the accessed raw data is further preprocessed to generate the training and validation datasets 310. Preprocessing may be implemented by the data subsystem 305, serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Raw data preprocessing may comprise data synthesis and/or data augmentation. Different data synthesis and/or data augmentation techniques (e.g., techniques described above) may be implemented by the data subsystem 305 to generate preprocessed data to be used for the training and validation subsystem 315. The synthesized data should be realistic enough to effectively train a machine learning model, but distinct enough to comply with regulations (e.g., privacy regulations and ethical guidelines), if necessary. Data augmentation is used to artificially expand the size of a dataset by creating modified versions of existing data examples. The primary goal of data augmentation is to increase variation in the data in order to make the model more robust to variations it might encounter in the real world, thereby improving its ability to generalize from the training data to unseen data.

Other raw data preprocessing techniques include data cleaning, normalization, feature extraction, dimensionality reduction, and the like. Data cleaning may involve removing duplicates, filling in missing values or words, or filtering out outliers to improve data quality. For example, words like “and,” “the,” or “is” that do not contribute much meaning but add unnecessary noise may be removed from the raw data and excluded from training. In some instances, when a dialogue is incomplete or cut off, it can be removed or attempt to impute missing parts (e.g., using another trained LLM). Normalization involves scaling numeric values to a common scale without distorting differences in the ranges of values, which helps prevent biases in the model due to the inherent scale of features. In some instances, normalization involves transforms text into a standard format, ensuring consistency across the dataset. For example, words may be reduced to their root form (e.g., converting “booking” to “book”) helps models generalize better and reduces vocabulary size. Feature extraction involves transforming the input data into a set of useable features, possibly reducing the dimensionality of the data in the process. In some instances, conversational data is broken down into smaller units like words, sub-words, or characters by a tokenizer like Byte-Pair Encoding (BPE) or WordPiece, allowing machine learning models to handle rare or unseen words effectively. The grammatical role of the tokenized data may be identified, and features such as meaningful entities may then be extracted for training or fine-tuning the machine learning models. The number of features depends on the project's need, for example, about tens of features to about thousands features (e.g., 2,048 features) may be extracted. It should be understood that more or less features may be considered.

Dimensionality reduction techniques like principal component analysis (PCA) may be used to reduce the number of variables under consideration, by obtaining a set of principal variables. These techniques not only help in reducing the computational load on the model but also in mitigating issues like overfitting by simplifying the data without losing critical information.

In the instance that machine learning pipeline 300 is used for supervised or semi-supervised learning of machine learning models, labeling techniques can be implemented as part of the data preprocessing. The quality and accuracy of data labeling directly influence the model's performance, as labels serve as the definitive guide that the model uses to learn the relationships between the input features and the desired output. Particularly in complex domains such as LLM training, precise and consistent labeling significantly enhances the model's ability to understand, classify, and generate relevant responses. Effective labeling ensures that the model is trained on correct and clear examples, thus enhancing its ability to generalize from the training data to real-world scenarios. For example, in a customer service LLM, labeling user queries with intents like “reset password” or “track order” helps the model classify similar queries in the future. Labeled data is also essential for fine-tuning them on specific tasks. In some instances, the ground truth value is provided within the raw data. In some instances, human annotators manually tag some or all of the raw data based on predefined rules, domains, tasks, or categories.

In some instances, the ground truth values (labels) are provided within the raw data. For example, for a digital assistant in a customer support context, the raw user query “I would like to cancel my order” can be labeled with an intent such as “Order_Cancellation,” indicating the user's goal. Additionally, the word “order” would be labeled as the entity “Product_Order,” marking it as a key part of the conversation. Optionally, sentiment analysis could label the tone as “Neutral.” By labeling text with these features, the model learns to recognize intents, extract relevant entities, and understand the overall sentiment, improving its ability to respond accurately in future interactions.

Labeling techniques can vary significantly depending on the type of data and the specific requirements of the project. Manual labeling, where human annotators label the data, is one method that can be used. This approach may be useful when a detailed understanding and judgment are required, such as in labeling or categorizing text data where context and subtlety are important. However, manual labeling can be time-consuming and prone to inconsistency, especially with a large number of annotators. To mitigate this, semi-automated labeling tools may be used as part of data subsystem 305 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

### C. Data Splitting

The training and validation datasets 310 may comprise the raw data, the manufactured data (e.g., the synthetic data), and/or the preprocessed data. The training and validation datasets 310 are typically split into at least three subsets of data: training, validation, and testing. The training subset is used to fit the model, where the model is configured to make inferences based on the training data. The validation subset, on the other hand, is utilized to tune hyperparameters and prevent overfitting to the training data. Finally, the testing subset serves as a new and unseen dataset for the model, used to simulate real-world applications and evaluate the final model's performance. In some instances, the datasets 310 are used for model fine-tuning. The process of splitting ensures that the model can perform well not just on the data it was trained on, but also on new, unseen data, thereby validating and testing its ability to generalize.

Various techniques can be employed to split the data effectively, aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated techniques may be necessary to preserve the underlying distribution of data. For instance, stratified sampling may be used to ensure that each split reflects the overall distribution of a specific variable, particularly useful in cases where certain domains, categories, tasks, responses, or outcomes are underrepresented. Another technique, k-fold cross-validation, involves rotating the validation set across different subsets of the data, maximizing the use of available data for training while still holding out portions for validation. These techniques help in achieving more robust and reliable model evaluation and are useful in the development of predictive models that perform consistently across datasets. In an example case, 70-80% of the data is used for training, 10-15% for validation to tune hyperparameters and monitor performance, and the remaining 10-15% to evaluate the final model performance.

### D. Hyperparameters

Data subsystem 305 can also be used for collecting, storing, generating, setting, or implementing model hyperparameters 340 for the training and validation subsystem 315. The hyperparameters control the overall behavior of the models. Unlike model parameters 345 that are learned automatically during training, model hyperparameters 340 are settings that are external to the model and usually determined before training begins. Model hyperparameters 340 can have a significant impact on the performance of the model. For example, in a neural network, model hyperparameters 340 include the learning rate, number of layers, number of neurons per layer, and/or activation functions, among others; in a random forest, model hyperparameters 340 may include the number of decision trees in the forest, the maximum depth of each decision tree, the minimum number of samples required to be at each leaf node, the maximum number of features to consider when looking for a best split, and/or bootstrap parameters. These settings can determine how quickly a model learns, its capacity to generalize from training data to unseen data, and its overall complexity. For example, in fine-tuning a model, lower learning rates are used to avoid catastrophic forgetting, where the model may lose valuable pre-trained knowledge.

Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal. Correctly setting hyperparameters for training of LLMs is critical to achieving optimal performance and avoiding common issues like overfitting or underfitting. Important hyperparameters include the learning rate, which controls how fast or slow the model's parameters are updated; batch size, which determines how many samples the model sees before updating weights; and epochs, which represent the number of times the model will see the entire training dataset. If the learning rate is too high, the model may not converge or could diverge, while a very low learning rate can make training unnecessarily slow. Similarly, batch size and epochs must be carefully tuned to balance between efficient learning and computational expense. Additionally, optimizers like Adam or Stochastic Gradient Descent need to be chosen and tuned correctly for the task to ensure efficient convergence during training.

In fine-tuning of trained LLMs, hyperparameters need to be adjusted with special care. Since the model has already been pre-trained on a large dataset, lower learning rates are generally recommended to avoid catastrophic forgetting, where the model may overwrite the knowledge gained during pre-training. Other hyperparameters like dropout rates (to prevent overfitting), and gradient clipping (to handle exploding gradients in large models) can also be important to stabilize the fine-tuning process. Fine-tuning also involves balancing between generalization and task-specific learning, which may require experimenting with hyperparameters over several runs. The validation set plays an important role during this phase by helping fine-tune hyperparameters dynamically, ensuring the model adapts well to the task-specific data without losing its general understanding from pre-training.

### (II) Training and Validation Subsystem

The training and validation subsystem 315 is comprised of a combination of specialized hardware and software to efficiently handle the computational demands required for training, validating, and testing machine learning algorithms/models. On the hardware side, high-performance Graphics Processing Units (GPUs) may be used for their ability to perform parallel processing, drastically speeding up the training of complex models, especially deep learning networks. Central Processing Units (CPUs), while generally slower for this task, may also be used for less complex model training or when parallel processing is less critical. Tensor Processing Units (TPUs), designed specifically for tensor calculations, provide another level of optimization for machine learning tasks. In some instances, Field-Programmable Gate Arrays (FPGAs) (or specifically designed FPGAs), Application-Specific Integrated Circuits (ASICs), Neural Processing Units (NPUs), and/or Vision Processing Units (VPUs) may also be used to perform the training, validating, and/or testing tasks. In some instances, the training and the validation (or the testing) processes are performed on different hardware, depending on the requirements and availability of resources. For example, the training can happen on high-performance hardware such as GPUs or TPUs, the validation is performed on different, lower-power hardware such as CPUs or NPUs, and testing the trained model using a same or different hardware for validation (e.g., a CPU or an edge device where the digital assistant with the trained LLM to be implemented).

### (A) The Training Phase

Training is the initial phase of developing machine learning models 330 where the model learns to make predictions, classifications, or decisions based on training data provided from the training and validation datasets 310. During this phase, the model iteratively adjusts its internal model parameters 345 to achieve a predetermined optimization condition. In a supervised machine learning training process, the predetermined optimization condition can be achieved by minimizing the difference between the model output (e.g., predictions, classifications, or decisions) and the ground truth labels in the training data. In some instances, the predetermined optimization condition can be achieved when the predetermined fixed number of iterations or epochs (full passes through the training dataset) is reached. In some instances, the preset optimization condition is achieved when the performance on the validation dataset stops improving or starts to degrade. In some instances, the predetermined optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 315, the training subset of data is input into the machine learning algorithms 320 to find a set of model parameters 345 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 320 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 345 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 320), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a random forest consisting of a collection of decision trees, the model architecture may include the configuration of features used by the decision trees, the voting scheme, and hyperparameters such as the number of trees in the forest, the maximum depth of each tree, the minimum number of samples required to split a node, and the maximum number of features to consider when looking for the best split. In some instances, the model architecture is configured to perform multiple tasks. For example, a first component of the model architecture may be configured to perform a feature selection function, and a second component of the model architecture may be configured to perform a feature scoring function. The different components may correspond to different algorithms or models, and the model architecture may be an ensemble of multiple components.

Model architecture also encompasses the choice and arrangement of features and algorithms used in various models, such as decision trees or linear regression. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The model architecture can encompass a wide range of algorithms 320, suitable for different kinds of tasks and data types. Examples of algorithms 320 include, without limitation, linear regression, logistic regression, decision tree, support vector machines, Naive Bayes algorithm, Bayesian classifier, linear classifier, K-Nearest Neighbors, K-Means, random forest, dimensionality reduction algorithms, grid search algorithm, genetic algorithm, AdaBoosting algorithm, gradient boosting machines, and artificial neural networks such as convolutional neural network (“CNN”), an inception neural network, a U-Net, a V-Net, a residual neural network (“Resnet”), a transform neural network, a recurrent neural network, a Generative adversarial network (GAN), or other variants of deep neural networks (“DNN”) (e.g., a multi-label n-binary DNN classifier or multi-class DNN classifier). These algorithms can be implemented using various machine learning libraries and frameworks such as TensorFlow, PyTorch, Keras, and scikit-learn, which provide extensive tools and features to facilitate model building, training, validation, and testing.

The learning algorithm is the overall method or procedure used to adjust the model parameters 345 to fit the data. It dictates how the model learns from the data provided during training. This includes the steps or rules that the algorithm follows to process input data and adjust the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 315 to train machine learning models 330 using the learning algorithm, depending on the type of model and the specific task. For supervised learning models, where the training data includes both inputs and expected outputs (e.g., ground truth labels), gradient descent is a possible method. This technique iteratively adjusts the model parameters 345 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 345 is performed by the optimization function or algorithm, which refers to the specific method used to minimize (or maximize) the objective function. The optimization function is the engine behind the learning algorithm, guiding how the model parameters 345 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or Root Mean Square Propagation (RMSprop), which provide different ways to adjust learning rates or take advantage of the momentum of changes.

For example, in training a neural network, backpropagation may be used with gradient descent to update the weights of the network based on the error rate obtained in the previous epoch (cycle through the full training dataset). In training a transformer model, which is based on a self-attention mechanism that allows the model to weigh the importance of different words in a sentence, regardless of their position, the entire input sequence is processed at once using layers of attention, where each word is represented in relation to all others. This structure allows for parallelization, speeding up training for very large datasets, making it highly efficient for text processing tasks. For example, Generative Pre-trained Transformer (GPT) is a model trained to predict the next token in a sequence based on the context of the previous tokens, enabling it to generate coherent text, and Bidirectional Encoder Representations from Transformers (BERT) is trained using masked language modeling (MLM), where certain words in a sentence are randomly masked, and the model learns to predict the missing words by understanding both the left and right context surrounding the masked token. Other transformer models (e.g., Text-to-Text Transfer Transformer (T5) or XLNet) or sequence-to-sequence models (e.g., Seq2Seq, Bidirectional and Auto-Regressive Transformers (BART)) may also be used for handling tasks from text classification to translation and summarization.

Another technique in supervised learning is the use of decision trees, where a tree-like model of decisions is built by splitting the training dataset into subsets based on an attribute value test. This process is repeated on each derived subset in a recursive manner called recursive partitioning. In training a random forest, the set of decision trees can be trained collectively to minimize a Gini impurity or entropy, leading to accurate classification.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Training an LLM using training data involves feeding the model vast amounts of text (or conversational data) to help it learn patterns, structures, and relationships in language. The model may be trained on large datasets containing diverse text sources, such as books, websites, or articles. During training, the model processes text data by breaking it down into smaller units, like words or tokens, and learns to predict the next token based on context, enabling it to generate coherent sentences. Through iterative adjustments using algorithms like stochastic gradient descent (SGD) or Adam, the model updates its internal weights to minimize prediction errors, gradually improving its ability to understand and generate text. This training process requires substantial computational resources, typically utilizing GPUs or TPUs to handle the large-scale data and model parameters efficiently. Training LLMs is primarily considered unsupervised or self-supervised. In this process, the model is trained on vast amounts of raw text data without explicit labels or predefined categories. Instead of relying on labeled datasets, LLMs learn by predicting the next word or token in a sequence based on the context provided by the previous words. For example, given a sentence with a missing word, the model learns to generate or predict that missing word, allowing it to grasp patterns and structure in language.

Fine-tuning a trained LLM for specific tasks (such as text classification, question-answering, or sentiment analysis) can be done in a supervised manner, using labeled data. This process helps the model adapt its general understanding of language to specialized tasks where labeled examples are available. In some instances, fine-tuning the LLM is performed using training data including synthetic data in the training and validation dataset 310. For example, synthetic dialogs can be generated to simulate real-world conversations between users and a digital assistant. Examples of these conversations might include varied ways users could request a pizza, such as “Can I get a large pepperoni pizza?” or “I want a vegetarian pizza with extra cheese delivered to my address.” These synthetic dialogs would encompass diverse user inputs, including requests for toppings, delivery time, or payment options. Fine-tuning the LLM on such synthetic data ensures the model understands the nuances of different domains or tasks (e.g., pizza ordering) and can respond accurately. By training the model on a variety of these simulated interactions, it becomes more robust and capable of handling actual user queries in real time, making it a valuable asset for customer service in digital assistant platforms. Synthetic data can also be generated quickly, saving both time and resources. It allows the model to be fine-tuned efficiently while maintaining high-quality performance without relying on extensive human-labeled data. Additionally, synthetic data allows for simulating edge cases where hallucinations are more likely, such as vague or incomplete user queries. This controlled exposure helps the model learn when to defer a response, seek more information, or stick to known facts, minimizing the risk of generating misleading or erroneous content. By repeatedly encountering these scenarios during fine-tuning, the LLM becomes better equipped to handle uncertainty without resorting to hallucination, leading to improved overall performance and reliability in real-world applications.

### (B) The Validation Phase

Validating is another phase of developing machine learning models 330 where the model is checked for deficiencies in performance and the hyperparameters 340 are optimized based on validation data provided from the training and validation datasets 310. The validation data helps to evaluate the model's performance, such as accuracy, precision, or recall, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training dataset is split into 5 equal-size cohorts (or about equal-size), and every four of the cohorts are used to train an algorithm to generate five models (e.g., cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire dataset for both training and evaluation and reduces the variance in the performance estimate.

### (C) The Testing Phase

Once a machine learning model has been trained and validated, it undergoes a final evaluation using testing data provided from the training and validation datasets 310, which is a separate subset of the training and validation datasets 310 that generally has not been used during the training or validation phases. This step can be important as it provides an unbiased assessment of the model's performance in simulating real-world operation. The test dataset serves as new, unseen data for the model, mimicking how the model would perform when deployed in actual use. During testing, the model's predictions are compared against the true values in the test dataset using various performance metrics such as accuracy, precision, recall, and mean squared error, depending on the nature of the problem (classification or regression). This process helps to verify the generalizability of the model-its ability to perform well across different data samples and environments-highlighting potential issues like overfitting or underfitting and ensuring that the model is robust and reliable for practical applications. The machine learning models 330 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), and the like.

When the model is an LLM, testing involves evaluating the model across a range of tasks (or domains) to ensure performance, robustness, and reliability. Common testing methods include benchmark evaluations (such as General Language Understanding Evaluation (GLUE), SuperGLUE, and/or Stanford Question Answering Dataset (SQuAD)), custom task testing for domain-specific applications, and generalization tests on unseen data. These techniques help determine how well the model handles text classification, translation, question answering, and task-specific scenarios like interacting with a digital assistant. Robustness testing ensures the LLM can cope with ambiguous, noisy inputs or unfamiliar situations without compromising performance. Additionally, bias and ethical testing help assess whether the model produces outputs that are free of societal, racial, or gender biases. These tests can be important for models that will interact with users in diverse, real-world applications.

In some instances, the testing areas include hallucination detection. This testing focuses on evaluating the model's ability to generate factually correct and contextually appropriate responses, particularly in high-stakes domains like healthcare, finance, or customer service. To minimize hallucinations, LLMs may be evaluated using knowledge-grounded tasks, where their outputs are compared against known factual information. Human-in-the-loop evaluation also plays a role, as human feedback can highlight cases where the model produces responses that, while coherent, deviate from the truth. By addressing hallucinations, testing ensures the reliability of LLMs and their suitability for real-world applications where factual accuracy is critical.

### (I) Inference Subsystem

The inference subsystem 325 is comprised of various components for deploying the machine learning models 330 in a production environment. Deploying the machine learning models 330 includes moving the models from a development environment (e.g., the training and validation subsystem 315, where it has been trained, validated, and tested), into a production environment where it can make inferences on real-world data (e.g., input data 350). This step typically starts with the model being saved after training and validation, including its parameters and configuration such as final architecture and hyperparameters.

Once deployed, the model (or models 330) is ready to receive input data 350 and return outputs (e.g., inferences 355, such as a response or an output prompt). In some instances, the model resides as a component of a larger system or service (e.g., including additional downstream applications 335, such as an Agent-based Digital Assistant (ADA) and/or Oracle Digital Assistant (ODA)). In some instances, the models 330 and/or the inferences 355 can be used by the downstream applications 335 to provide further information. For example, the inferences 355 can be used to determine a state of an action, whether a slot is missing or needs to be filled, and/or whether a follow-up prompt should be generated and prompted to a user of a digital assistant. The downstream applications can be configured to generate an output 360. In some instances, the output 360 comprises knowledge outputs, semantic outputs, API outputs, and/or other suitable outputs.

In an exemplary inference subsystem 325 deployed in a digital assistant, the input data 350 includes natural language utterances, including text input, voice input, image input, or any other suitable input for the digital assistant. The input data 350 may For example, the input data 350 may include text input provided by the user via a keyboard or touchscreen of a computing device used by the user. In other examples, the input data 350 may include spoken words provided by the user via a microphone of the computing device. In other examples, the input data 350 may include image data, video data, or other media provided by the user via the computing device. Additionally or alternatively, the input data 350 may include indications of actions to be performed by the digital assistant on behalf of the user. For example, the input data 350 may include an indication that the user wants to order a pizza, that the user wants to update a retirement account contribution, or other suitable indications.

In some instances, the input data 350 may be preprocessed before inputting into the models 330 to achieve a faster model performance. For example, the input data 350 may be provided to a planner (e.g., the planner 208 described in FIG. 2) of the digital assistant. The planner may generate an execution plan (e.g., the execution plan 210 described in FIG. 2) based on the input data 350 and based on context provided to the planner. The planner may receive the input data 350 and may make a call to a semantic context and memory store (e.g., the context and memory store 214 described in FIG. 2) to retrieve the context. In some instances, the semantic context and memory store includes one or more assets (e.g., the assets 219 described in FIG. 2), which may be knowledge, API, dialog history, or the like. The planner may provide at least a portion of the input data 350 to the semantic context and memory store, which can perform a semantic search on the assets and/or other knowledge included in the semantic context and memory store. The semantic search may generate a list of candidate actions, from among all actions that can be performed via one or more of the assets, that may be used to address the input data 350 or any subset thereof. In some instances, the candidate actions may be generated only based on contextual information. For example, the input data 350 may be compared with metadata of the actions to generate the candidate actions. The preprocessing may reduce the dimensions of the input data 350 and thus save computing time and resources (e.g., requiring less computer memory) in the inference stage to generate the inferences 355. In some instances, the preprocessing or a portion thereof has been integrated to be a part of the models 330 through model training or fine-tuning.

In some instances, the planner includes or is included by the models 330 of the inference subsystem 325. A planner model may use the candidate actions to form an input prompt for a second generative artificial intelligence model that can be used to generate an execution plan. The second model may be or be included in the models 330. The planner model may be communicatively coupled with the second mode via a common language model interface layer (CLMI layer). For example, the planner model may generate an input prompt and may provide the input prompt to the CLMI layer that can convert the input prompt into a model-specific input prompt for being input into the second model. The planner model may receive output from the second model, and the output may be or include the execution plan. In some instances, the output may be used as input by the planner model to allow the planner model to generate the execution plan. The output may include a list that includes one or more executable actions based on the utterance included in the input data 350. In some instances, the execution plan may include an ordered list of actions to execute for addressing the input data 350.

To manage and maintain its performance, a deployed model may also be continuously monitored to ensure it performs as expected over time. This involves tracking the model's prediction accuracy, response times, and other operational metrics. Additionally, the model may require retraining or updates based on new data or changing conditions. This can be useful because machine learning models can drift over time due to changes in the underlying data they are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Block Diagram for Fine-Tuning Large Language Models for Digital Assistants

FIG. 4 is a block diagram of an exemplary system 400 for large language model fine-tuning in accordance with various embodiments. The system 400 may be implemented as a part of the DABP 105 (e.g., as part of the digital assistant builder tools 120 or the one or more of the digital assistants 115) as described in FIG. 1 and/or as a part of the machine learning pipeline 300 as described in FIG. 3. The system 400 comprises a data manufacturing subsystem 410, a model management subsystem 420, and a model fine-tuning subsystem 430. The system and subsystems depicted in FIG. 4 may be implemented in software (e.g., code, instructions, program) executed by one or more processing units (e.g., processors, cores) of the respective computing systems or hardware. The software may be stored on a non-transitory storage medium (e.g., on a memory device). The system and subsystems presented in FIG. 4 and described below is intended to be illustrative and non-limiting.

### (i) Data Manufacturing Subsystem

Digital assistants (DAs) are designed to interact with users through natural language, assisting with tasks such as setting reminders, answering questions, managing schedules, and controlling smart devices. These assistants leverage artificial intelligence (AI) and machine learning (ML) to understand and process user inputs, respond with relevant information, and learn from user preferences to improve over time. Digital assistants rely on various models and architectures to process user inputs and respond accordingly. These models have evolved from simple rule-based systems to more complex ones, including ML models and large language models (LLMs).

LLM-based DAs are driven by pre-trained LLMs that employ advanced deep learning techniques to understand and generate human language. Although the pre-trained LLMs enable DAs to perform a wide range of tasks such as handling ambiguous queries and generating natural-sounding responses, challenges such as hallucinations, computational intensity, and maintaining factual accuracy are inherent drawbacks that need to be addressed.

Fine-tuning allows the pre-trained LLMs (and the LLM-based DAs) to serve as sophisticated tools in fields and domains such as personal, customer service, and business contexts. Fine-tuning a pre-trained LLM involves taking the pretrained LLM and further training it on a more specific dataset to adapt its behavior for particular tasks. Various techniques like transfer learning can be applied to retain the core understanding of language while adapting to the new context, enabling the model to generate more relevant and accurate outputs for the particular tasks.

Fine-tuning pre-trained LLMs presents several challenges. First, the process demands significant computational resources, as it requires substantial memory and processing power to fine-tune large models efficiently. Second, the quality and quantity of training data have a significant impact on the final output of the fine-tuned model. In some instances, the dataset is desired to be task-specific and large enough to ensure the model can generalize effectively. However, using too much data can lead to overfitting, where the model becomes too specialized to the fine-tuning data and struggles with new inputs. On the other hand, insufficient or low-quality data can cause underfitting, leading the model to perform poorly on its intended tasks. Additionally, overfitting and underfitting both contribute to the risk of hallucinations. When the training data is too narrow or unrepresentative, the model may fail to generalize properly, increasing the likelihood of hallucinations; if the data contains inconsistencies or gaps, the model may default to relying on patterns learned during pre-training, potentially producing erroneous outputs. Ensuring bias mitigation is thus challenging, and improper fine-tuning can introduce or amplify biases in the model's outputs, affecting its accuracy and reliability.

To address the challenges and limitations, techniques provided herein (e.g., using the data manufacturing subsystem 410) enable the generation of synthetic data. This synthetic data can be leveraged to fine-tune a pre-trained LLM, ensuring that the LLM-based digital assistant adheres accurately and consistently to natural language configuration commands, minimizing errors and enhancing fidelity in responses. Moreover, the synthetic data generation techniques are optimized to use less memory and processing power compared to traditional fine-tuning processes, thus improving both the fine-tuning efficiency and the overall performance of implementing LLM-based digital assistants.

As shown in FIG. 4, the data manufacturing subsystem 410 may include a prompt database 411, a dialog script database 413, a task/domain database 415, an asset database 417, a training data accessor 412, a synthetic data generator 414, a content extractor 416, and a data preprocessor 418. The data manufacturing subsystem 410 is capable of accessing training data (e.g., using the training data accessor 412) and generating synthetic data (e.g., using the synthetic data generator 414). Both the accessed training data and the synthetic data can be used for fine-tuning a pre-trained LLM. In some instances, only the synthetic data is used to fine-tune the pre-trained LLM.

A pre-trained LLM is generally fine-tuned for a specific digital assistant (DA) or a DA to perform specific tasks. For example, when a pizza restaurant owner (e.g., user 110 described in FIG. 1) wants to create a DA for their restaurant (e.g., enabling customers to order pizzas or book tables), the DABP 105 described in FIG. 1 may be used to create the specific DA for the pizza restaurant owner. The data manufacturing subsystem 410 can be embedded into the DABP 105. After the DABP 105 receives the request from the user 110 to create the specific DA, the DABP 105 may determine the domain and/or tasks related to the specific DA (e.g., using one or more models provided by the model management subsystem 420. For example, the DABP 105 may determine that the domain for the specific DA is “restaurant,” and the synthetic data to be generated by the synthetic data generator 414 is restaurant-specific data. In some embodiments, the user 110 is given various domains to select from, and one or more domains may be selected. The domain determination or selection may be provided using the task/domain database 415 of the data manufacturing subsystem 410. For example, the task/domain database 415 includes libraries for domains, tasks, or matched domains and tasks, and a whole library or a portion thereof may be provided to the user 110 to select from. In some embodiments, a LLM may be fine-tuned to perform the domain determination and the LLM is used by the DABP 105 or the data manufacturing subsystem 410 to determine one or more domains that for the user 110 to create the specific DA. In some instances, the user 110 may further fine-tune a domain-specific LLM (a pre-trained LLM that has been fine-tuned for a specific domain) for particular tasks, and the task/domain database 415, the data manufacturing subsystem 410, and/or the DABP 105 may function similarly to provide task selection, determination, and fine-tuning.

In some instances, entities hosting the DABP 105 can fine-tune LLMs and provide the fine-tuned LLM-based DAs through the DABP 105. Comparing to a user creating a specific DA and waiting for a system or platform to fine-tune an LLM or a DA, preparing the fine-tuned LLMs before a user's request help improve the user experience and further improve the efficiency of the DA implementation. Additionally, preparing the fine-tuned LLMs using the techniques disclosed herein further integrate prompts and dialog scripts into the synthetic data generating process, which further reduce computational costs and resource demands. Furthermore, the techniques include multi-task fine-tuning, which further reduce the risk and probability of hallucinations. The techniques can also be implemented in real time, and the training data (including new synthetic data) can be used in real time to fine-tune a pre-trained or previously fine-tuned LLM and prompt or deliver response(s) in real time (e.g., less than 20 milliseconds (ms), less than 100 ms, or less than 200 ms) or in semi real time (e.g., greater than 200 ms but less than a few seconds).

Multiple components (e.g., databases and or the modules) of the data manufacturing subsystem 410 can act together as a synthetic data generation pipeline to generate synthetic data for fine-tuning a pre-trained LLM for a specific domain. In some embodiments, the synthetic data generation pipeline begins with accessing an action retriever prompt template. The action retriever prompt template may be stored in the prompt database 411, or generated based on data (e.g., prompts) in the prompt database 411. In some embodiments, the action retriever prompt template is designated or defined by a user 110 who wants to create or deploy a specific DA. The action retriever prompt template is customizable, providing flexibility in addressing LLM weaknesses (e.g., hallucinations) through training data.

Table 1 provides an example of an action retriever prompt template. The order of each item or slot in the template can be changed. More items or slots can be added to the template. Existing items or slots may also be removed from the template. It should be understood that the example in Table 1 is not intended to be exclusive. Various templates can be generated, designed, adapted, and accessed by the synthetic data generation pipeline for generating synthetic data.

TABLE 1
Action Retriever Prompt Template
You are an agent to help decide which action to take
based on the user question and context information.

| IMPORTANT: | You should only respond in JSON format with a correct “Action Plan”. | |
|---|---|---|
| | Ensure the complete response can be parsed by Python json.loads | |
| | Date argument values must be formatted to “YYYY-MM-DD” and Time | |
| | argument values must be formatted to “HH:MM:SS” | |
| Candidate Actions: | {candidate_actions} | |
| Context Information: | User Profile: | {user_profile} |
| | Conversation History: | {conversation_history} |
| | Action Plan: | {existing_action_plan} |
| | Current Date & Time: | {current_date_time} |

| | |
|---|---|
| Question: | {question} |
| Response: | {response} |

The action retriever prompt template is used to generate synthetic data. Not all slots in the template need to be filled out for training or fine-tuning purposes. For example, a filled action retriever prompt provided in Table 2 does not include a response.

TABLE 2
Example Action Retriever Prompt
You are an agent to help decide which action to take based on the user question and context information.

| IMPORTANT: | You should only respond in JSON format with a correct “Action Plan”. | |
|---|---|---|
| | Ensure the complete response can be parsed by Python json.loads | |
| | Date argument values must be formatted to “YYYY-MM-DD” and Time | |
| | argument values must be formatted to “HH:MM:SS” | |
| Candidate | Action 1: “ReserveRestaurant”: | |
| Actions: | Agent: Restaurants | |
| | Description: Make a table reservation at a restaurant | |
| | args JSON schema: [{“name”: “restaurant_name”, “description”: “Name of | |
| | the restaurant”, “type”: “String”}, {“name”: “city”, “description”: “City in | |
| | which the restaurant is located”, “type”: “String”}, {“name”: “time”, | |
| | “description”: “Time for the reservation or to find availability”, “type”: “Time”}, | |
| | {“name”: | |
| | “date”, “description”: “Date for the reservation or to find availability”, | |
| | “type”: “Date”}, {“name”: “party_size”, “description”: “Party size for a reservation”, | |
| | “type”: “Integer”, “options”: [“1”, “2”, “3”, “4”, “5”, “6”]}] | |
| | required args: [“restaurant_name”, “city”, “time”] | |
| | “one of” required args: [ ] | |
| | Action type: API_CALL | |
| Context | User Profile: | employee_id: 772596 |
| Information: | | name: Debra Timothy Garcia |
| | | age: 68 |
| | Conversation | User: I am feeling hungry so I need to find a place to eat and |
| | History: | also for the place to be serving alcohol. |
| | | Assistant: Do you have a specific city in mind where you |
| | | would like for the place to be? |
| | | User: I will be walking around Healdsburg so I want for it to |
| | | be there. |
| | | Assistant: Can you tell me the type of food you would like |
| | | for the place to have? |
| | | User: I like eating Ramen sometimes so that kind of food |
| | | would be nice. |
| | | Assistant: I see that 1 restaurant fits with what you want |
| | | called The Taste of Tea. The restaurant can be found in |
| | | Healdsburg. |
| | | User: Can you tell me the phone number which I can use to |
| | | contact them? |
| | | Assistant: If you want to phone them you can through 707- |
| | | 431-1995. |
| | | User: Can you tell me if they feature live music there? How |
| | | much do the things cost in general there? |
| | | Assistant: The price of the products they offer is moderate. |
| | | Unfortunately I see that they do not have a live music. |
| | | User: Alright, that is nice for me. |
| | | Assistant: Do you want to book a table at this restaurant? |
| | | User: Yes, I would like to eat there, so I want to make a |
| | | reservation for afternoon 1:15. |
| | | Assistant: Can you please confirm to me that you want to |
| | | make a reservation for 2 people at The Taste Of Tea in |
| | | Healdsburg? You want the reservation to be for today at 1:15 |
| | | pm? |
| | Action | “action”: “ReserveRestaurant”, |
| | Plan: | “agent”: “Restaurants”, |
| | | “args”: { |
| | | “restaurant_name”: “The Taste of Tea”, |
| | | “city”: “Healdsburg”, |
| | | “time”: “13:15:00”, |
| | | “date”: null, |
| | | “party_size”: null |
| | Current Date & Time: | 2019-03-01 01:45:00 |

| | |
|---|---|
| Question: | “That's not what I want. I forgot about a couple that will join us so the reservation |
| | should be for four people and on the 8th.” |
| Response: | N/A |

Similarly, not all slots in Table 2 need to be filled-out at a single time. In some instances, one or more candidate actions are first generated and filled in the template to provide fine-tuning data. In some instances, the one or more candidate actions are stored in a database of the data manufacturing subsystem 410 and accessed by the synthetic data generation pipeline. For example, candidate actions may be stored in the task/domain database 415 or the asset database 417 of the data manufacturing subsystem 410, or a candidate action database that is not shown in FIG. 4. In some instances, the one or more candidate actions are generated by a model provided by the model management subsystem 420. The one or more candidate actions may be generated by the model based on historical dialogs stored in the dialog script database 413 and/or prompts in the prompt database 411. In some instances, the one or more candidate actions are generated using API specifications, and the API specifications can be stored internally in the asset database 417 of the data manufacturing subsystem 410 or externally (e.g., in a cloud or cloud service that is a separate system of the system 400). In some instances, the one or more candidate actions are defined or created manually by a user (e.g., the user 110 describe in FIG. 1) or semi-manually by the user with the assistance of tools (e.g., LLMs, API specifications, or the tools 120 described in FIG. 1).

In some instances, multiple candidate actions are generated, accessed, and/or filled out. The total number of the candidate actions may be predetermined by the system 400 or by a user of the system. The total number of the candidate actions can be at least 2, 3, 4, 5, 6, 7, 8, 9, or 10. In some instances, the total number of the candidate actions is within a range, e.g., [2, 10], [10, 100], or [100, 5000]. The limits (e.g., lower limit, upper limit) to the total number can be determined based on the specific domain or tasks. In some instances, the candidate actions include an out-of-domain (OOD) action. Table 3 provides five example candidate actions, including an OOD action.

TABLE 3
Example Candidate Actions

| Candidate Actions | Details |
|---|---|
| “FindApartment”: | Agent: Homes |
| | Description: Find an apartment in a city for a given number of bedrooms |
| | args JSON schema: [{“name”: “area”, “description”: “City where the apartment is |
| | located”, “type”: “String”}, {“name”: “number_of_beds”, |
| | “description”: “Number of bed rooms”, “type”: “Integer”, “options”: [“1”, “2”, “3”, “4”]}, |
| | {“name”: “furnished”, “description”: “Boolean flag indicating if the |
| | property is furnished”, “type”: “Bool”, “options”: [“True”, “False”]}, {“name”: |
| | “pets_allowed”, “description”: “Boolean flag indicating if pets are allowed”, |
| | “type”: “Bool”, “options”: [“True”, “False”]}, {“name”: “number_of_baths”, “description”: |
| | “Number of baths in the apartment”, “type”: “Integer”, “options”: |
| | [“1”, “2”, “3”, “4”]}] |
| | required args: [“area”, “number_of_beds”] |
| | “one of” required args: [ ] |
| | Action type: API_CALL |
| “ScheduleVisit” | Agent: Homes |
| | Description: Schedule a visit for a given property on a particular date |
| | args JSON schema: [{“name”: “property_name”, “description”: “Name of the apartment”, |
| | “type”: “String”}, {“name”: “visit_date”, “description”: “Date |
| | for the visit to the apartment”, “type”: “Date”}] |
| | required args: [“property_name”, “visit_date”] |
| | “one of” required args: [ ] |
| | Action type: API_CALL |
| “ReserveRestaurant” | Agent: Restaurants |
| | Description: Make a table reservation at a restaurant |
| | args JSON schema: [{“name”: “restaurant_name”, “description”: “Name of the |
| | restaurant”, “type”: “String”}, {“name”: “city”, “description”: “City in |
| | which the restaurant is located”, “type”: “String”}, {“name”: “time”, “description”: “Time |
| | for the reservation or to find availability”, “type”: “Time”}, {“name”: |
| | “date”, “description”: “Date for the reservation or to find availability”, “type”: “Date”}, |
| | {“name”: “party_size”, “description”: “Party size for a reservation”, |
| | “type”: “Integer”, “options”: [“1”, “2”, “3”, “4”, “5”, “6”]}] |
| | required args: [“restaurant_name”, “city”, “time”] |
| | “one of” required args: [ ] |
| | Action type: API_CALL |
| “FindRestaurants” | Agent: Restaurants |
| | Description: Find a restaurant of a particular cuisine in a city |
| | args JSON schema: [{“name”: “cuisine”, “description”: “Cuisine of food served in the |
| | restaurant”, “type”: “String”, “options”: [“Mexican”, “Chinese”, |
| | “Indian”, “American”, “Italian”]}, {“name”: “city”, “description”: “City in which the |
| | restaurant is located”, “type”: “String”}, {“name”: “price_range”, |
| | “description”: “Price range for the restaurant”, “type”: “String”, “options”: [“inexpensive”, |
| | “moderate”, “expensive”, “very expensive”]}, {“name”: |
| | “has_live_music”, “description”: “Boolean flag indicating if the restaurant has live music”, |
| | “type”: “Bool”, “options”: [“True”, “False”]}, {“name”: |
| | “serves_alcohol”, “description”: “Boolean flag indicating if the restaurant serves alcohol”, |
| | “type”: “Bool”, “options”: [“True”, “False”]}] |
| | required args: [“cuisine”, “city”] |
| | “one of” required args: [ ] |
| | Action type: API_CALL |
| “OOD_Action” | Agent: OOD agent |
| | Description: No matching action for the given question |
| | args JSON schema: [ ] |
| | required args: [ ] |
| | “one of” required args: [ ] |
| | Action type: OOD |

The OOD action enables synthesize training data that can be used, when fine-tuning the LLMs, to enhance the robustness, adaptability, and generalization capabilities of the LLMs. Including synthetic OOD data in fine-tuning the pre-trained LLMs helps the LLM develop a better ability to generalize beyond its training domain, and make the LLMs more robust (e.g., mitigating the overfitting issues and/or hallucinations) when encountering unfamiliar or noisy data in real-world scenarios.

Conversation history data may be generated based on one or more candidate actions. Conversation history data may also be accessed using the data manufacturing subsystem 410 or generated based on other slots in the action retriever prompt template. As shown in Table 2, the conversation history slot is filled with a conversation (e.g., utterances between a user and a digital assistant) regarding reserving a restaurant (“ReserveRestaurant”). The history conversation may be generated by an LLM obtained from the model management subsystem 420. In some instances, the history conversation is generated based on dialog script stored in the dialog script database 413 and/or the asset database 417. In some instances, the history conversation is associated with the other context information such as a user profile and/or a previously generated or accessed conversation. In some instances, a history conversation relates to more than one candidate actions. In some instances, a conversation relates to multiple types of the candidate actions (e.g., an API-call action, a knowledge-based action). An API-call action refers to an action to perform a task or retrieve an information on behalf of a user using an API. A knowledge-based action refers to an action that requires knowledge sources and the action need to be taken based on the knowledge. In some embodiments, the API or knowledge sources (e.g., a menu of a restaurant) may be stored internally in the asset database 417 or stored externally in a cloud or a remotely connected computer memory. In some instances, a conversation can be both an API-call action and a knowledge-based action. In some instances, the history conversation relates to none of the candidate actions. The history conversation data may be used to generate questions, or the conversation itself may be used as a prompt and/or response. In some instances, the history conversion data is unavailable and is not necessary to generate prompts and/or responses.

An action plan is also generated for training or fine-tuning the LLM. In some embodiments, the action plan is determined based on one or more candidate actions and/or the conversation (or conversation history data). In some embodiments, the action plan is generated using an LLM (e.g., a planner LLM) obtained from the model management subsystem 420. In some instances, the action plan is generated using the planner 208 described in FIG. 2. In some embodiments, the action plan is generated based on contents extracted from the conversation using the content extractor 416. The content extractor 416 may be supported by an ML model, a tokenizer, or an LLM obtained from the model management subsystem 420. The content extractor 416 may help reduce the data needs to be processed in fine-tuning, and further improve the overall efficiency of the synthetic data generation pipeline. In some embodiments, the action plan is an existing action plan stored in the system 400, for example, in one of the databases of the data manufacturing subsystem 410.

One or more questions or prompts are generated based on one or more of the information or slots in the template as discussed herein. For example, a prompt can be generated based on the action plan. The prompt may be generated by an LLM obtained from the model management subsystem 420, or by the synthetic data generator 414 of the data manufacturing subsystem 410. In some embodiments, the prompt is designed to provide further information for the missing slots in the action plan. For example, the “party_size” slot information is missing from the action plan shown in Table 2, and the prompt in Table 2 provides the missing information (the party size to be four). A prompt may provide information for one missing slot or multiple missing slots.

In some embodiments, one or more responses are generated for the one or more prompts. The one or more responses may be generated based on the action retriever prompt template (e.g., Table 1), or based on a response template. The one or more responses may confirm a receipt of information in the prompt, update slots in the action plan, seek for missing information, and/or confirm an execution plan. In some embodiments, the one or more responses are generated by an LLM obtained from the model management subsystem 420, or by the synthetic data generator 414 of the data manufacturing subsystem 410. For example, a response is generated asking a clarification question to a user to gather information need for slot-filling or to disambiguate between ambiguous concepts that are picked up by the action plan.

A portion or all of the information generated or accessed based on the action retriever prompt template and the response template using the synthetic data generation pipeline may be used as the synthetic data for fine-tuning. For example, the conversation history data may be used as the fine-tuning data and the corresponding prompts are used as labels (or ground truth) of the fine-tuning data. In some instances, the prompts and corresponding responses are used as the fine-tuning data and their labels, respectively. Using a portion or all of the synthetic data may depend on the computing cost and time, and a pre-determined fine-tuning purpose.

In some embodiments, additional training data is acquired or accessed using the training data accessor 412. The training data can be obtained from a public dataset such as the Schema Guided Dialogue (SGD) dataset, which is comprised of over 20,000 annotated multi-domain task-oriented conversations between human and a digital assistant. Other public or private datasets that are task-oriented can also be used for fine-tuning. For example, Multi-Domain Wizard-of-Oz Dataset (MultiWOZ), datasets used for the Dialogue State Tracking Challenge (DSTC) (e.g., DSTC8, DSTC9), Taskmaster (TM) series (e.g., TM-1, TM-2. TM-3), Stanford's Multi-Turn, Multi-Domain, Task-Oriented Dialogue Dataset, and/or ConvLab-2 datasets can be accessed using the training data accessor 412 for fine-tuning. These training data is then supplemented with the synthetic data generated using the synthetic data generation pipeline.

One of the problems associated with the existing training data (data obtained from public datasets) for fine-tuning a pre-trained LLM model is the existing training data is often happy-path data. That is, the data (e.g., utterances, conversations, prompts, or responses) is in-order data that provides sequential information. However, models fine-tuned using the happy-path data cannot efficiently handle and respond to prompts in complex scenarios. For example, the happy-path data does not cover scenarios wherein conversation is an out of order dialog flow (e.g., secondary happy path) or when a conversation continues and deviates from an original action plan that is determined based on first several utterances (e.g., non-sequitur).

The synthetic data enhances the training data by adding secondary-happy-path data and non-sequitur data. For example, the synthetic data can be categorized into multi-action data (data involving in a scenario that relates to multiple actions, e.g., a conversation for finding restaurants and reserve a restaurant), multi-type-of-action data (data relates to, e.g., both API and knowledge), OOD data (domain of the conversation cannot be found in databases or by the data manufacturing subsystem 410), multi-type data (e.g., data value is a string, an array, an object, an integer, a float, a data tuple, a time stamp, a time series, or another structured data type used to represent a combination of multiple data elements), multi-task data (data involving multiple tasks to be executed in each action, or multiple tasks to be performed by a digital assistant). The synthetic data can include both happy-path data, secondary-happy-path data and non-sequitur data, and the proportion of each type of data may be predetermined or may be set as a hyperparameter for the fine-tuning and determined through model validation. For example, a synthetic dataset may include about 5×-6× of happy-path data, about 2×-3× of secondary-happy-path data, and about 10×-11× of non-sequitur data, with “x” being any integer (e.g., 1, 10, 100, 1000, 10000, or greater than 10000). Another synthetic dataset may include about 7×-8× of happy-path data, about 1×-2× of secondary-happy-path data, and about 13×-14× of non-sequitur data. The proportion may be predetermined based on an estimated proportion of the real-world examples (e.g., based on a statistical estimation on a certain population). In some instances, the synthetic dataset may further include a certain proportion of synthetic data of a specific category. For example, at least 30% of data in a synthetic dataset is multi-action data. In some embodiments, a ratio of the synthetic data to the training data is also predetermined. For example, when the training set includes 20,000 training data, the synthetic dataset can include about 16 synthetic data to about 12,000 synthetic data.

The diversified synthetic dataset ensures that high-quality, diverse and unbiased conversational data is included for efficiently fine-tuning LLMs to simulate digital assistant workflows including response generation and effectively avoiding or mitigating hallucinations. To further enhance the efficiency and accuracy of LLM fine-tuning for the specific digital assistant, sub-tasks including action routing and slot-filling can be pre-defined, for example, after the specific domain for the DA is determined. When defining the sub-tasks, inputs, output, and their respective formats are also defined. For example, routing is a task to convert or match an utterance to a candidate action, an agent, an intent, or an asset. The routing can be performed using a routing LLM based on metadata (e.g., name, description, knowledge asset, action, API, and the like) associated with the utterance. Slot-filling is a task to determine or collect specific information (e.g., slots) to respond to a prompt or complete an action plan. The slot-filling can be performed using a slot-filling LLM based on the utterance. The routing LLM and the slot-filling can be two different pre-trained LLMs or a same pre-trained LLM. The fine-tuning can result in two different LLMs even the LLMs before fine-tuning are the same LLM.

Different sets of synthetic data may be generated using the synthetic data generator 414 via the synthetic data generation pipeline. For example, after templates (action retriever prompt template, response template) are created, slots to the templates are filled with diversified data such that the synthetic data covers varying complexities in different scenarios (e.g., 3 actions, 2 types of actions, and 4 slots to be filled). The slots can be used as the synthetic dataset for fine-tuning the routing LLM.

Slot-filling helps teach the LLM to understand a scenario when it does not have enough information to respond appropriately to a user request or prompt. For example, when two ambiguous concepts are involved, the LLM may generate hallucinated results because it is unable to determine which action to pick or which slot to fill. The pre-fine-tuned LLM may randomly pick one concept and generate inaccurate, incorrect, logically inconsistent, or fabricated responses. Fine-tuning a slot-filling LLM involves training the model to generate responses that ask clarifying questions in order to gather the necessary information for slot-filling or to resolve ambiguity between similar concepts. To fine-tune the model effectively, synthetic data can be generated using diverse slot-filling scenarios, including varying numbers of slots (none or 1-n slots, with n equal to a positive integer), different slot types (integer, float, strings, date, time, and the like), and both required and optional slots. The synthetic data also includes scenarios where no additional prompt is needed (e.g., all information is provided), user input without any slots filled, happy-path data, and secondary-happy-path data. In some embodiments, additional sub-tasks (e.g., response refining, execution plan generation) may be included and additional synthetic data may be generated for fine-tuning corresponding LLM(s). It should be understood that each of the above-mentioned LLMs may be obtained from the model management subsystem 420, and each of the LLMs may be a same LLM or different LLMs.

After defining the sub-tasks and generating synthetic data for each sub-task, data preprocessing can be performed, for example, using the data preprocessor 418 of the data manufacturing subsystem 410. For example, the training data obtained by the training data accessor 412 may be divided into datasets for sub-tasks, and the divided training data is combined with the synthetic data to form the fine-tuning data. In some embodiments, the fine-tuning data may be tokenized, normalized, and/or filtered using the data preprocessor 418 before being used to fine-tune the LLMs. Data tokenization involves the process of breaking down data (utterances, conversations, dialogs, texts) into smaller units called tokens. Data normalization involves transforming the data into a consistent format, for example, stripping out punctuation marks or reducing words to their base or root form. Data filtering can remove unwanted or irrelevant part of a data entry, or completely remove a data record that is unwanted or irrelevant (e.g., a data record with conversations that are nonsense or a duplicated data record). In some embodiments, the preprocessing also includes merging the fine-tuning dataset in a way that the LLM(s) can understand. For example, when each dataset corresponds to a specific task, the data preprocessor 418 may prepend a unique identifier to each entry. When the dataset corresponds to multiple tasks, multiple identifiers may be prepended and an “and” token may be added to help the LLM understand that different tasks are to be performed.

The fine-tuning data or preprocessed fine-tuning data can be split into different datasets for different training stages by the data manufacturing subsystem 410. For example, 70%-80% of the data is used for training stage, 10%-15% for validation stage, and remaining (10%-15%) data for testing stage. In some embodiments, the data split is performed by a different subsystem of the system 400.

### (ii) Model Management Subsystem

Model management subsystem 420 is designed to manage and provide models, while also facilitating interactions with both the data manufacturing subsystem 410 and the model fine-tuning subsystem 430. As shown in FIG. 4, the model management subsystem 420 includes a model database 421, a model selector 422, and an optional model generator 424. More databases and modules may be included in the model management subsystem 420, depending on the system design or user need.

The model database 421 stores pre-trained models that are manageable and accessible by the model management subsystem 420. Different models may be stored in the database with associated metadata including algorithms, parameters, and hyperparameters. The models can be machine learning models or deep learning models. For example, different LLMs can be stored in the model database 421. For example, the LLM used to generate history conversation data can be stored in the model database 421 and obtained by the data manufacturing subsystem 410.

The model selector 422 may select models that are suitable for performing a specific task and provide the selected models to other subsystems of the system 400. For example, the model selector 422 may select the LLM that is suitable for generating history conversation data and send the data to the data manufacturing subsystem 410. In some instances, the model selection is performed based on the metadata associated with the models. For example, metadata of a model may include a name that describes the function of the model, and the model selector 422 selects specific models based on the names of the models. In some instances, the model selector is configured based on a machine learning model (e.g., an LLM) and perform the selection using the ML model.

In some embodiments, the model generator generates a model for performing a specific task. The generated model can be a simple linear regression model, or a complex LLM that demands larger dataset for configuration such as training and validation.

The model management subsystem 420 may be implemented to select or generate a suitable LLM as the base model for fine-tuning. Suitable LLMs may include the GPT models, the Large Language Model Meta AI (LLaMA), or the like. Different models may be selected based on their performance. For example, a GPT-4 model may be selected because it has enhanced understanding and text generation capabilities, making it suitable for intricate analysis, document drafting, and research. The LLaMA model can provide robust language processing with potentially lower computational requirements, making it easier to integrate into existing workflows or pipelines (e.g., the synthetic data generation pipeline used by the data manufacturing subsystem 410) and more accessible for deployment in diverse computing environments. Other language models such as BERT, T5, XLNet, ALBERT may also be considered and selected by the model management subsystem 420.

In some embodiments, the model management subsystem 420 further ensure that the architecture of the selected model is capable of handling the specific task or tasks. For example, a selected model for performing routing should be able to handle multi-action detection and matching tasks. In some instances when a single LLM is fine-tuned to perform multiple sub-tasks (e.g., both routing and slot-filling), the model management subsystem 420 may be configured to ensure the LLM architecture enables using task-specific heads on top of the model.

(iii) Model Fine-Tuning Subsystem

The model fine-tuning subsystem 430 is designed to implement fine-tuning models provided by the model management subsystem 420 using the fine-tuning data provided by the data manufacturing subsystem 410. The model fine-tuning subsystem 430 can be configured to set multi-task learning environment and/or parameters, hyperparameters, and variables for the fine-tuning. The model fine-tuning subsystem 430 may include modules that are configured to perform domain-level, task-level, or sub-task level fine-tuning. As shown in FIG. 4, the model fine-tuning subsystem 430 include a routing module 432, a slot-filling module 434, a response generation module 436, and two optional modules: a dialog enhancement module 437 and a content enhancement module 438. It should be understood that additional modules and different modules may be included in the model fine-tuning subsystem 430, depending on the need (e.g., the specific domain for the DA) and/or task or sub-task configuration (e.g., configured by the data manufacturing subsystem 410).

In some embodiments, the model fine-tuning subsystem 430 implements a mechanism to identify domains, tasks, or sub-tasks the specific digital assistant (and the underlying LLM(s)) is configured to perform. The identification may be based on a user or system input. For example, the specific token may be used to indicate that the LLM is used in a digital assistant facilitating restaurant-related services. In some instances, embedding layers of the LLM architecture may indicate the domains, tasks, or sub-tasks. In some instances, the identification is made based on the data stored in the databases of the data manufacturing subsystem 410.

The model fine-tuning subsystem 430 is also configured to define objective measurements to evaluate the performance of the model being fine-tuned. In some instances, the objective measurements include one or more loss functions that guide the learning process of the model, enabling optimization through methods such as gradient-based methods. In some instances, a single loss function is defined for the fine-tuning process. In some instances, one loss function is defined for each fine-tuning module (e.g., when training a routing LLM, a loss function is defined for the routing LLM), and multiple loss functions are combined together for evaluating the overall performance.

As shown in FIG. 4, when fine-tuning involves multiple modules (e.g., the routing module 432, the slot-filling module 434) to perform multiple sub-tasks (e.g., routing, slot-filling), task-specific loss functions may be defined for each task. The loss functions can one or more of the followings: a cross-entropy loss, a mean squared error (MSE), a negative log-likelihood loss, a mean absolute error (MAE), a hinge loss, a Huber loss, and a combination of one or more of the loss functions. It should be understood that different loss functions or custom loss functions can be defined and used for fine-tuning the LLM module.

The model fine-tuning subsystem 430 may also determine if each module has a different LLM to be fine-tuned, or if multiple modules share the same LLM. For example, when a transformer model with encoder layers and decoder layers is used for multi-task learning/fine-tuning, the shared encoder layers can process the input in each module to generate embeddings that can be used across all modules, and the fully connected sub-task-specific layers can take the embeddings to produce output for each module. The loss function to the evaluate the overall performance can be a composite loss function taking a weighted sum of the sub-task loss functions. Other LLMs with different architectures can be configured in a similar way.

The routing module 432 is configured to perform routing fine-tuning and the slot-filling module 434 is configured to perform slot-filling fine-tuning. After initializing the LLM for each module with its pre-trained parameters, the training set of the fine-tuning data is then loaded into the model. The training data may be loaded into each module batch-batch. For example, for each batch of the fine-tuning data, a forward pass through the modules (e.g., shared encoders and task-specific layers) is performed to compute an output, and a loss (or a composite loss) is determined for this forward pass. A backward pass is then performed to compute gradients with respect to the loss and model parameters are updated according to the loss and gradients.

After all training data is loaded, a model validation process is performed using the validation set of the fine-tuning data. Validation involves monitoring the performance of the fine-tuning process and the model being fine-tuned, and adjust hyperparameters of the LLMs to optimize performance. In some instances, the validation is also used to early-stop the fine-tuning process to prevent overfitting. In some instances, after each batch of the training data is used in training, a periodic validation is performed using a batch of the validation data.

After fine-tuning and validation, the testing set of the fine-tuning data is used to determine the model performance on each sub-task and/or the overall performance. Appropriate metrics (e.g., F1-score, precision, recall, or the like) may be used to evaluate the performance of the fine-tuned LLM. This helps in understanding how well the model is performing on individual tasks and identifying areas for improvement. Experiments using data from public database and the synthetic data show that techniques disclosed herein improve model performance by 5% to 50%, compared with existing models performing different sub-tasks. With the implementation of fine-tuning using the specifically manufactured fine-tuning data, the overall accuracy can reach 98%, depending on the base model.

Once the metrics are computed, the results can be analyzed to ensure that the model performs satisfactorily across all tasks. The analysis may include identifying any trade-offs or performance drops that may occur when optimizing for one task over another. Optionally, the LLM can be further fine-tuned based on the testing, the analysis, or the detected trade-offs. The new training data can be obtained in a similar way as described in FIG. 4, or the fine-tuning set may be re-split to provide new training data. Details regarding the fine-tuning are described with respect to FIG. 3.

Once the model is fine-tuned, it can be deployed into the digital assistance, applications, or workflows. For example, the fine-tuned model can be used by an agent-based digital assistant system (or an Oracle digital assistant system), or an intent-based digital assistant system. The model performance after deployment can also be continuously monitored, e.g., based on the metrics or user feedback, to ensure it meets the expected standard. Periodic fine-tuning can be also scheduled to ensure that the model is compatible with new technologies and data.

In some embodiments, the model fine-tuning subsystem 430 also performs response generation using the response generation module 436. The response generation module 436 may be configured to generate a response based on the output of the slot-filling module 434. For example, when the output of the slot-filling module 434 is an action plan, the response generation module 436 identifies the missing information and generates a response seeking for input from the user to facilitate the information. The response generation module 436 may include the same LLM model or a different model to perform the missing slot identification and/or the response generation. The LLM of the response generation module 436 may be obtained from the model management subsystem 420 and fine-tuned at the same time with the fine-tuning of the LLM(s) in the routing module 432 and the slot-filling module 434, or it may be fine-tuned separately. Data used to fine-tune the LLM of the response generation module 436 may be the data generated by the slotting-filling module 434 or data manufactured by the data manufacturing subsystem 410.

The optional dialog enhancement module 437 and the optional content enhancement module 438 are designed to enhance the response generated by the response generation module 436. For example, the response is an utterance mimicking the response given by a real-world assistant, and the dialog enhancement module 437 uses a natural language model to enhance the mimicked response, e.g., by enhancing naturalness, empathy, and conversational flow between prompts and responses. For example, the dialog enhancement module 437 may takes personal embeddings and inject personality to the response. The personal embeddings can be a uniformed embedding, a captured embedding from the user. In some embodiments, the dialog enhancement module 437 also takes into account other user-related information, e.g., username and preference, conversation history, and the like. In some embodiments, the user-related information is provided by the data manufacturing subsystem 410.

The optional content enhancement module 438 uses machine learning models to enrich the response generated by the response generation module 436 with relevant details, examples, explanations, and additional context. For example, the ML models used by the optional content enhancement module 438 can break down complex concepts into detailed, easy-to-understand explanations, use specific examples to illustrate points more clearly, include relevant statistics or data to support the information, and/or anticipate follow-up prompts or responses. The ML models used by the optional content enhancement module 438 can also customize the response generated by the response generation module 436 to fit the specific domain or task of the digital assistant and/or needs of the user. Additional modules can also be included in the model fine-tuning subsystem 430 to further enhance the system 400.

### Flowchart for Fine-Tuning Large Language Models for Digital Assistants

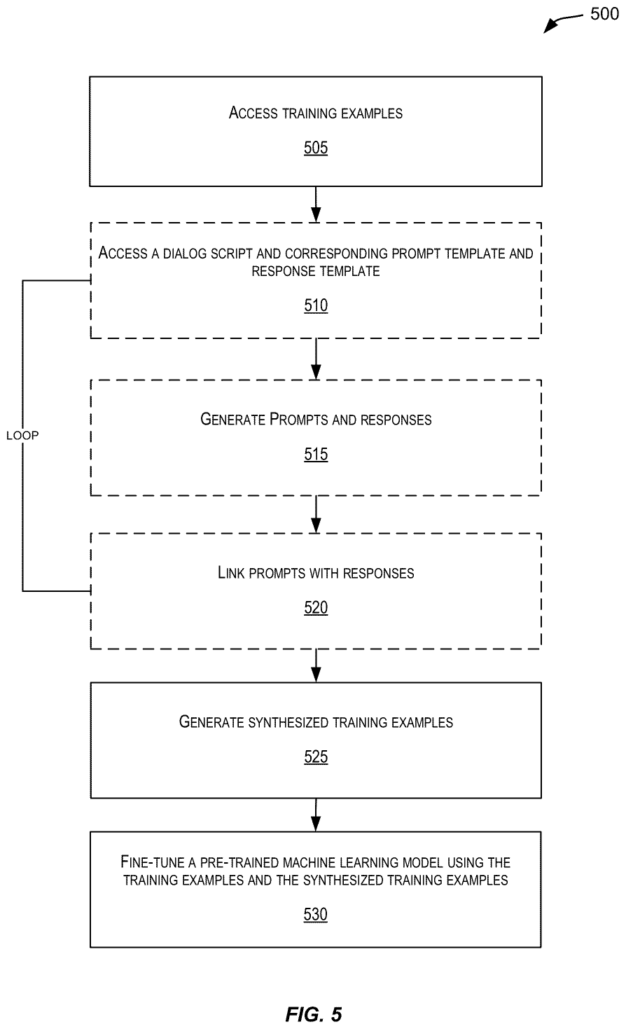

FIG. 5 is a flowchart of a process 500 for fine-tuning large language models for digital assistants in accordance with various embodiments. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 5 and described below is intended to be illustrative and non-limiting. Although FIG. 5 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 5 may be performed by one or more of the components, computing devices, systems, subsystems, services, or the like, illustrated and described with respect to FIGS. 1-4.

At block 505, training examples are accessed. Each training example depicts a conversation between a user and a digital assistant. The conversation may be based on a dialog script. The training examples may be accessed by retrieving data from a public database, a commercial database, and/or a private database. In some embodiments, the training examples are accessed using the training data accessor 412 described with respect to FIG. 4.

Optional blocks 510-520 provides steps to generate synthesized training examples. At block 510, a dialog script and corresponding prompt template and the response template are accessed. The dialog script, the prompt template, and the response template may be designed for a predefined scenario, e.g., for deploying a digital assistant for a pizza restaurant, or for a bank use. The dialog script may include information regarding an intent use of a machine learning model to be fine-tuned (a statement in natural language or an utterance that “You are an agent to help decide which action to take based on the user question and context information”). The dialog script may also include candidate actions, context information, and utterances. For example, candidate actions include actions related to finding an apartment (e.g., “FindApartment”, “ScheduleVisit”), actions related to finding a restaurant (e.g., “FindRestaurants”, “ReserveRestaurant”), and out-of-domain actions. The candidate actions may include actions related to a single domain, or actions related to multiple domains. Context information may include user information (e.g., user profile, user identification, username, age, or the like), conversation history data (e.g., a dialog between the user and the assistant), and/or an action plan.

In some embodiments, the history conversation data includes an in-order dialog flow between a user and a digital assistant (e.g., a happy-path dialog), an out of order dialog flow between a user and a digital assistant (e.g., a secondary happy-path dialog), or at least a portion of a dialog flow between a user and a digital assistant does not logically flow from another portion of the dialog flow (e.g., a non-sequitur dialog). Different dialog-flow scenarios reduce the probability of hallucination generated by a fine-tuned machine learning model and improve the overall accuracy and efficiency of the underlying digital assistant.

In some embodiments, the prompt template provides prompt placeholders associated with dialog script, such as the candidate actions, the context information, and/or an utterance. A prompt placeholder associated with the context information may include at least a portion of an action plan (or an execution plan). For example, an action plan may include information about the action, agent, argument, date and time, and the like, and a prompt placeholder include information or seek for information where such information is missing from the action plan. The prompt placeholder may also include information related to the execution plan, which comprises an action including at least one argument slot having missing values (e.g., an execution plan with an action to acquire information from the user). The utterance may also be provided by the prompt template, which comprises information for filling in the missing values.

In some embodiments where the response template is also accessed, the response template often includes response placeholders associated with executable actions. The response placeholder associated with the executable actions may include the same action that is included in the prompt placeholder, with the argument slot filled in with one or more response values, e.g., derived from the information in the utterance of the prompt placeholder.

In some embodiments, the prompt placeholders associated with the candidate actions include one or more argument slots to be filled by the digital assistant, and the response placeholders associated with the executable actions include the one or more argument slots filled with one or more response values. For example, the party size is a required information of a candidate action “ReserveRestaurant” and the information is missing based on the history conversation and/or the action plan. As a result, a prompt placeholder may be include the party size slot, and the response placeholder may be designed to output a response with the slot value being filled.

At block 515, prompts are generated based on the dialog script and corresponding prompt template for the predefined scenario, and responses are generated based on the dialog script and corresponding response template for the predefined scenario. In some embodiments, the prompts are generated by inserting prompt values into the prompt placeholders based on the dialog script for the predefined scenario, and the responses are generated by inserting response values into the response placeholders based on the dialog script for the predefined scenario and the associated one or more prompts.

In some embodiments, the prompts and the responses are generated using a same generative artificial intelligence model. In some embodiments, the model used to generate the prompts is different from the model used to generate the responses. In some embodiments, the prompts and/or the responses are generated by selecting the prompt values for the prompt placeholders and/or the response values for the response placeholders based on the dialog script for the predefined scenario. The selecting may be based on a random or predefined data split scheme. For example, the data split scheme causes the prompt values and the response values to be selected in such a manner that variation within the prompts and the responses is realized in (i) a number of the candidate actions and/or executable actions, (ii) a type of the candidate actions and/or executable actions, (iii) a number of tasks within the context information, (iv) a type of tasks within the context information, (v) a number of argument slots to be filled within the context and/or executable actions, (vi) a type of argument slots to be filled within the context and/or executable actions, when the prompt values and the response values are inserted into the prompt placeholders and the response placeholders, respectively. The data split scheme may be implemented in a dynamic manner through the iterative process (e.g., repeat steps in blocks 510, 515, and 520).

At block 520, the prompts and the responses generated at block 515 are linked accordingly. Each linked prompt(s) and response(s) can be used as a synthetic datapoint for the fine-tuning purposes. In some embodiments, the steps at blocks 510-520 are performed as an iterative process to generate synthetic datapoints of a desired size (e.g., based on a predetermined ratio between training data and synthetic data, described in the data manufacturing subsystem 410 with respect to FIG. 4). In some embodiments, the steps at blocks 510-520 are performed as an iterative process for each of the predefined scenarios to generate an enriched set of synthetic datapoints.

At block 525, the synthesized training examples are generated. The synthesized training examples may be generate based on a synthetic data generation pipeline described with respect to the data manufacturing subsystem 410 in FIG. 4. In some embodiments, the synthesized training examples are generated through the steps at blocks 510-520 performed as an iterative process. In some embodiments, the size of the synthesized training examples is determined (or controlled) by the data split scheme. The synthesized training examples can be further preprocessed (e.g., normalized) before being used in fine-tuning.

At block 530, a pre-trained machine learning model is fine-tuned using the training examples accessed at block 505 and the synthesized training examples generated at block 525. The pre-trained machine learning model is fine-tuned to learn information such as domains, tasks, actions, sub-tasks such as routing and slot-filling for generating an execution plan. In some embodiments, the fine-tuning is split into a sub-task of routing and a sub-task of slot-filling. The routing fine-tuning identifies the executable actions from the candidate actions that are relevant for responding to the utterance based on the context information, and slot-filling fine-tuning inserts values into argument slots associated with the executable actions based on the context information. In some embodiments, the pre-trained machine learning model is a large language model or a generative artificial intelligence model. The pre-trained machine learning model may be different from the model(s) used to generate the prompts and responses at block 515.

In some embodiments, the fine-tuning process begins by generating batches of examples selected from the set of training examples and the set of synthesized training examples. An iterative training loop process in then performed for each batch of examples. The iterative training loop process first inputs examples from each batch into the pre-trained machine learning model. Losses are determined for sub-tasks of routing and slot-filling. The model parameters are then optimized based on a combined loss function that takes into account the losses. After all batches have been process by the training loop process, the model with the updated parameters can be validated using a validation process and further testing may be performed to determine a final performance of the model.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

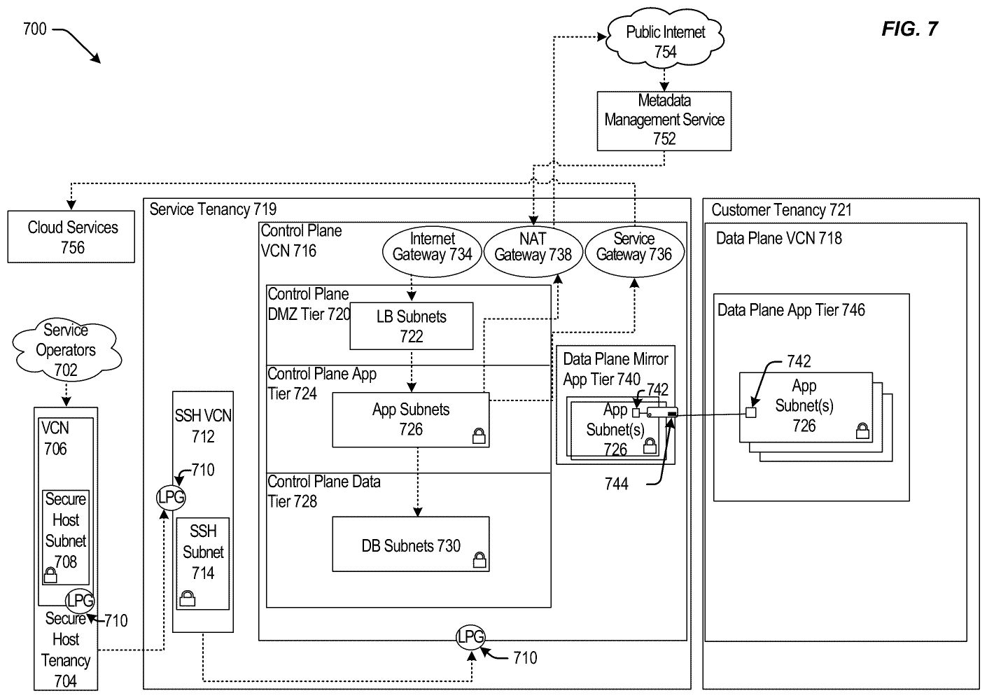

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

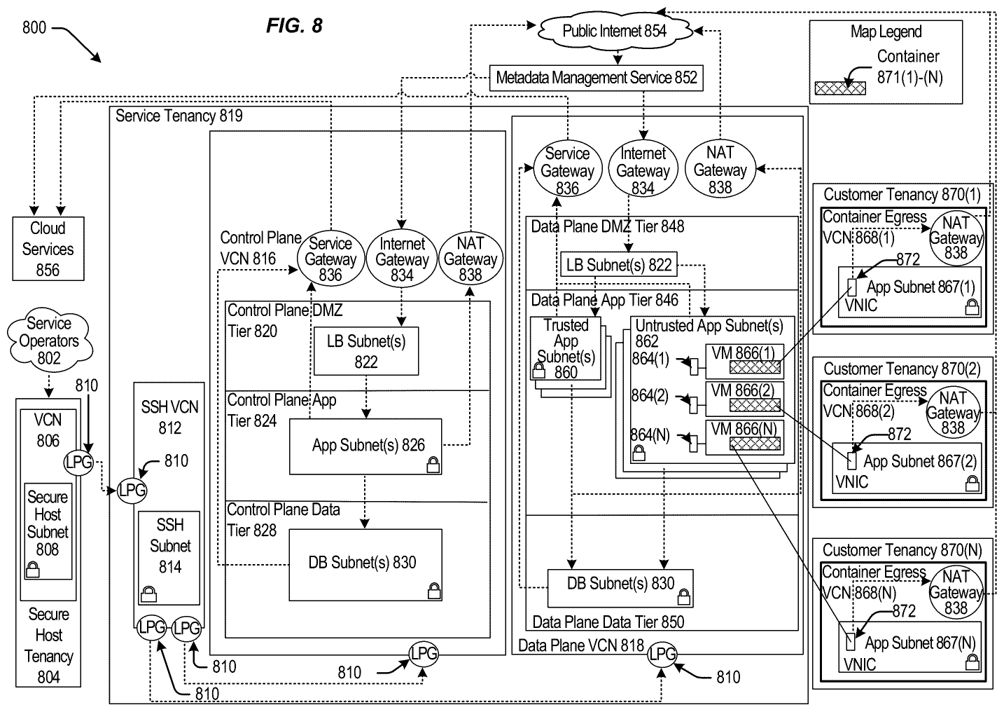

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

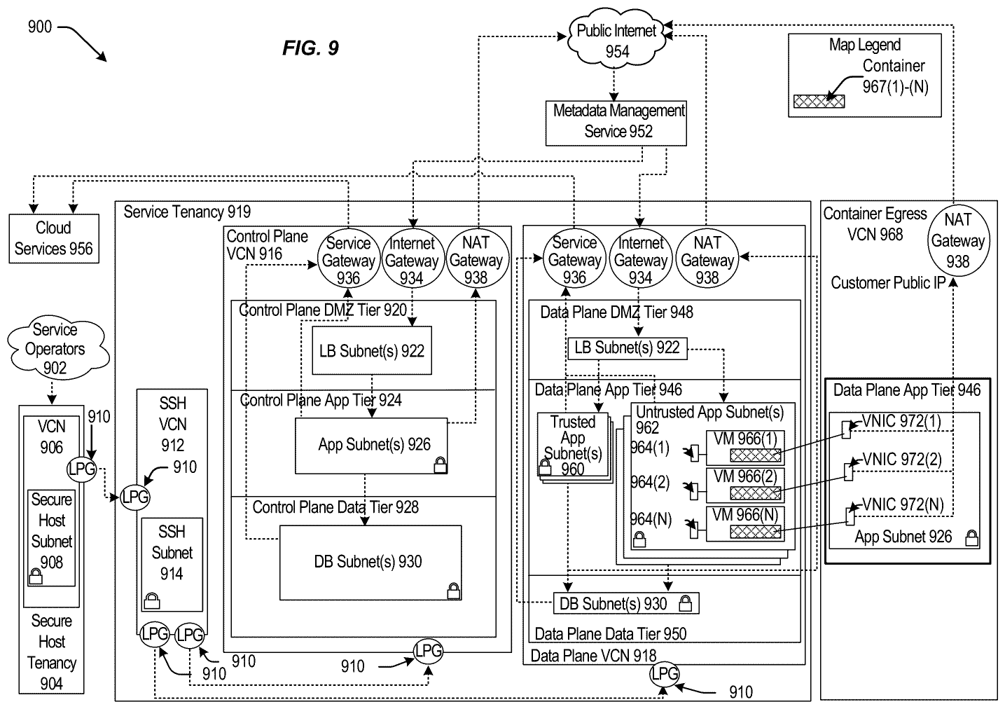

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

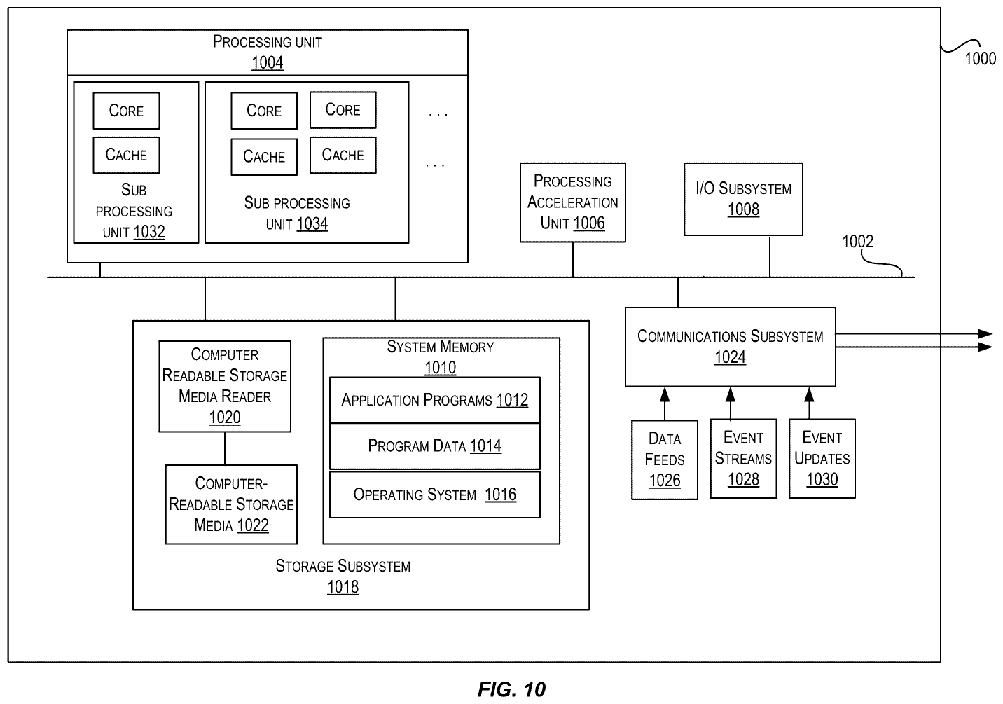

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing a set of training examples, wherein each training example of the set of training examples comprises a dialog script between a user and a digital assistant;
generating a set of synthesized training examples using an iterative process that is performed for each of one or more predefined scenarios, wherein the iterative process comprises;
accessing a dialog script and corresponding prompt template and response template for a predefined scenario, wherein the prompt template comprises prompt placeholders associated with candidate actions, context, and an utterance, and wherein the response template comprises response placeholders associated with executable actions;
generating one or more prompts based on the dialog script and corresponding prompt template for the predefined scenario, wherein generating the one or more prompts comprises inserting prompt values into the prompt placeholders associated with the candidate actions, the context, and the utterance based on the dialog script for the predefined scenario;
generating one or more responses associated with each of the one or more prompts based on the dialog script and the response template for the predefined scenario, wherein generating the one or more responses comprises inserting response values into the response placeholders associated with the executable actions based on the dialog script for the predefined scenario and the associated one or more prompts; and
linking each of the one or more responses with each of the associated one or more prompts to generate one or more synthesized training examples in the set of synthesized training examples; and
fine-tuning, using the set of training examples and the set of synthesized training examples, a pre-trained machine learning model to learn tasks of action routing and slot-filling for generating an execution plan, wherein the action routing comprises identifying one or more of the executable actions from one or more of the candidate actions that are relevant for responding to the utterance based on the context, and slot-filling comprises inserting values into argument slots associated with the one or more executable actions based on the context.

2. The computer-implemented method of claim 1, wherein generating the one or more prompts and the one or more responses further comprises selecting, using a random or predefined data split scheme, the prompt values for the prompt placeholders and the response values for the response placeholders based on the dialog script for the predefined scenario, and wherein the random or predefined data split scheme causes the prompt values and the response values to be selected in such a manner that variation within the one or more prompts and the one or more responses is realized in a number of the candidate actions and/or executable actions, type of the candidate actions and/or executable actions, number of tasks within the context, type of tasks within the context, number of argument slots to be filled within the context and/or executable actions, type of argument slots to be filled within the context and/or executable actions, or any combination thereof when the prompt values and the response values are inserted into the prompt placeholders and the response placeholders, respectively.

3. The computer-implemented method of claim 2, wherein the dialog script for the predefined scenario comprises an in-order dialog flow between a user and a digital assistant, an out of order dialog flow between a user and a digital assistant, or at least a portion of a dialog flow between a user and a digital assistant does not logically flow from another portion of the dialog flow.

4. The computer-implemented method of claim 3, wherein the prompt placeholders associated with the candidate actions include one or more argument slots to be filled by the digital assistant, and the response placeholders associated with the executable actions include the one or more argument slots filled with one or more response values.

5. The computer-implemented method of claim 3, wherein the prompt placeholders associated with the context include at least a portion of an execution plan, the execution plan comprises an action including at least one argument slot having missing values, the utterance comprises information for filling in the missing values, the response placeholders associated with the executable actions include the action including the at least one argument slot, and the at least one argument slot is filled in with one or more response values derived from the information in the utterance.

6. The computer-implemented method of claim 1, wherein the fine-tuning comprises:
generating batches of examples selected from the set of training examples and the set of synthesized training examples; and
performing an iterative training loop process that comprises:
inputting examples from the batches into the pre-trained machine learning model;
for each batch, computing a loss for the task of action routing;
for each batch, computing a loss for the task of slot-filling; and
optimizing model parameters based on a combined loss function that takes into account the loss for the task of action routing and the loss for the task of slot-filling.

7. The computer-implemented method of claim 1, wherein the one or more prompts and the one or more responses are generated using a generative artificial intelligence model.

8. A system comprising:
one or more processors; and
one or more computer-readable media storing instructions which, when executed by the one or more processors, cause the system to perform operations comprising:
accessing a set of training examples, wherein each training example of the set of training examples comprises a dialog script between a user and a digital assistant;
generating a set of synthesized training examples using an iterative process that is performed for each of one or more predefined scenarios, wherein the iterative process comprises;
accessing a dialog script and corresponding prompt template and response template for a predefined scenario, wherein the prompt template comprises prompt placeholders associated with candidate actions, context, and an utterance, and wherein the response template comprises response placeholders associated with executable actions;
generating one or more prompts based on the dialog script and corresponding prompt template for the predefined scenario, wherein generating the one or more prompts comprises inserting prompt values into the prompt placeholders associated with the candidate actions, the context, and the utterance based on the dialog script for the predefined scenario;
generating one or more responses associated with each of the one or more prompts based on the dialog script and the response template for the predefined scenario, wherein generating the one or more responses comprises inserting response values into the response placeholders associated with the executable actions based on the dialog script for the predefined scenario and the associated one or more prompts; and
linking each of the one or more responses with each of the associated one or more prompts to generate one or more synthesized training examples in the set of synthesized training examples; and
fine-tuning, using the set of training examples and the set of synthesized training examples, a pre-trained machine learning model to learn tasks of action routing and slot-filling for generating an execution plan, wherein the action routing comprises identifying one or more of the executable actions from one or more of the candidate actions that are relevant for responding to the utterance based on the context, and slot-filling comprises inserting values into argument slots associated with the one or more executable actions based on the context.

9. The system of claim 8, wherein generating the one or more prompts and the one or more responses further comprises selecting, using a random or predefined data split scheme, the prompt values for the prompt placeholders and the response values for the response placeholders based on the dialog script for the predefined scenario, and wherein the random or predefined data split scheme causes the prompt values and the response values to be selected in such a manner that variation within the one or more prompts and the one or more responses is realized in a number of the candidate actions and/or executable actions, type of the candidate actions and/or executable actions, number of tasks within the context, type of tasks within the context, number of argument slots to be filled within the context and/or executable actions, type of argument slots to be filled within the context and/or executable actions, or any combination thereof when the prompt values and the response values are inserted into the prompt placeholders and the response placeholders, respectively.

10. The system of claim 9, wherein the dialog script for the predefined scenario comprises an in-order dialog flow between a user and a digital assistant, an out of order dialog flow between a user and a digital assistant, or at least a portion of a dialog flow between a user and a digital assistant does not logically flow from another portion of the dialog flow.

11. The system of claim 10, wherein the prompt placeholders associated with the candidate actions include one or more argument slots to be filled by the digital assistant, and the response placeholders associated with the executable actions include the one or more argument slots filled with one or more response values.

12. The system of claim 10, wherein the prompt placeholders associated with the context include at least a portion of an execution plan, the execution plan comprises an action including at least one argument slot having missing values, the utterance comprises information for filling in the missing values, the response placeholders associated with the executable actions include the action including the at least one argument slot, and the at least one argument slot is filled in with one or more response values derived from the information in the utterance.

13. The system of claim 8, wherein the fine-tuning comprises:
generating batches of examples selected from the set of training examples and the set of synthesized training examples; and
performing an iterative training loop process that comprises:
inputting examples from the batches into the pre-trained machine learning model;
for each batch, computing a loss for the task of action routing;
for each batch, computing a loss for the task of slot-filling; and
optimizing model parameters based on a combined loss function that takes into account the loss for the task of action routing and the loss for the task of slot-filling.

14. The system of claim 8, wherein the one or more prompts and the one or more responses are generated using a generative artificial intelligence model.

15. One or more non-transitory computer-readable media storing instructions which, when executed by one or more processors, cause the one or more processors to perform operations comprising:
accessing a set of training examples, wherein each training example of the set of training examples comprises a dialog script between a user and a digital assistant;
generating a set of synthesized training examples using an iterative process that is performed for each of one or more predefined scenarios, wherein the iterative process comprises;
accessing a dialog script and corresponding prompt template and response template for a predefined scenario, wherein the prompt template comprises prompt placeholders associated with candidate actions, context, and an utterance, and wherein the response template comprises response placeholders associated with executable actions;
generating one or more prompts based on the dialog script and corresponding prompt template for the predefined scenario, wherein generating the one or more prompts comprises inserting prompt values into the prompt placeholders associated with the candidate actions, the context, and the utterance based on the dialog script for the predefined scenario;
generating one or more responses associated with each of the one or more prompts based on the dialog script and the response template for the predefined scenario, wherein generating the one or more responses comprises inserting response values into the response placeholders associated with the executable actions based on the dialog script for the predefined scenario and the associated one or more prompts; and
linking each of the one or more responses with each of the associated one or more prompts to generate one or more synthesized training examples in the set of synthesized training examples; and
fine-tuning, using the set of training examples and the set of synthesized training examples, a pre-trained machine learning model to learn tasks of action routing and slot-filling for generating an execution plan, wherein the action routing comprises identifying one or more of the executable actions from one or more of the candidate actions that are relevant for responding to the utterance based on the context, and slot-filling comprises inserting values into argument slots associated with the one or more executable actions based on the context.

16. The one or more non-transitory computer-readable media of claim 15, wherein generating the one or more prompts and the one or more responses further comprises selecting, using a random or predefined data split scheme, the prompt values for the prompt placeholders and the response values for the response placeholders based on the dialog script for the predefined scenario, and wherein the random or predefined data split scheme causes the prompt values and the response values to be selected in such a manner that variation within the one or more prompts and the one or more responses is realized in a number of the candidate actions and/or executable actions, type of the candidate actions and/or executable actions, number of tasks within the context, type of tasks within the context, number of argument slots to be filled within the context and/or executable actions, type of argument slots to be filled within the context and/or executable actions, or any combination thereof when the prompt values and the response values are inserted into the prompt placeholders and the response placeholders, respectively.

17. The one or more non-transitory computer-readable media of claim 16, wherein the dialog script for the predefined scenario comprises an in-order dialog flow between a user and a digital assistant, an out of order dialog flow between a user and a digital assistant, or at least a portion of a dialog flow between a user and a digital assistant does not logically flow from another portion of the dialog flow.

18. The one or more non-transitory computer-readable media of claim 17, wherein the prompt placeholders associated with the candidate actions include one or more argument slots to be filled by the digital assistant, and the response placeholders associated with the executable actions include the one or more argument slots filled with one or more response values.

19. The one or more non-transitory computer-readable media of claim 17, wherein the prompt placeholders associated with the context include at least a portion of an execution plan, the execution plan comprises an action including at least one argument slot having missing values, the utterance comprises information for filling in the missing values, the response placeholders associated with the executable actions include the action including the at least one argument slot, and the at least one argument slot is filled in with one or more response values derived from the information in the utterance.

20. The one or more non-transitory computer-readable media of claim 15, wherein the fine-tuning comprises:
generating batches of examples selected from the set of training examples and the set of synthesized training examples; and
performing an iterative training loop process that comprises:
inputting examples from the batches into the pre-trained machine learning model;
for each batch, computing a loss for the task of action routing;
for each batch, computing a loss for the task of slot-filling; and
optimizing model parameters based on a combined loss function that takes into account the loss for the task of action routing and the loss for the task of slot-filling.
